(19) United States
(12) Patent Application Publication
(10) Pub. No.: US 2019/0116356 A1
(43) Pub. Date: Apr. 18, 2019

(54) INFORMATION PROCESSING APPARATUS, INFORMATION PROCESSING METHOD, AND PROGRAM

(71) Applicant: SONY CORPORATION, Tokyo (JP)

(72) Inventors: Masato MATOBA, Kanagawa (JP); Tessho ISHIDA, Kanagawa (JP)

(73) Assignee: SONY CORPORATION, Tokyo (JP)

(21) Appl. No.: 16/090,319

(22) PCT Filed: Feb. 7, 2017
(86) PCT No.: PCT/JP2017/004333

§ 371 Date: Oct. 1, 2018

(30) Foreign Application Priority Data
Apr. 15, 2016 (JP) 2016-081911
Nov. 4, 2016 (JP) 2016-216095

(51) Int. Cl. H04N 13/363; H04N 9/31

(52) U.S. Cl. CPC H04N 13/363; H04N 9/3102; H04N 9/3185

(57) ABSTRACT

An information processing apparatus according to an embodiment of the present technology includes an acquisition unit and a generation unit. The acquisition unit acquires setting information regarding projection of an image by an image projection apparatus. The generation unit generates a simulation image including a plurality of image projection apparatuses and respective display regions of a plurality of images projected by the plurality of image projection apparatuses on the basis of the acquired setting information.

### TECHNICAL FIELD

The present technology relates to an information processing apparatus, an information processing method, and a program capable of assisting the use of an image projection apparatus such as a projector.

### BACKGROUND ART

Patent Literature 1 describes a projector selection assist system that allows a user to appropriately select a projector. In the selection assist system, the type name of a projector, the size of a screen onto which an image is to be projected, and the arrangement of a desk are input by a user. By the input of the parameters, an image including a projector, reflected light, a screen, a desk, and a viewing area is displayed (paragraphs [0008] to [0010] and [0093] of the specification, FIG. 9, or the like of Patent Literature 1). In addition, Patent Literature 1 also describes a mode in which, when the layout of a desk, the number of viewers, and the presence or absence of illumination are input by a user, the type names of projectors adapted to the combinations of these parameters are displayed in a list form (paragraphs [0117] and [0134] of the specification, FIG. 15, or the like).

### CITATION LIST

### Patent Literature

Patent Literature 1: Japanese Patent Application Laid-open No. 2003-295309

### DISCLOSURE OF INVENTION

### Technical Problem

It is assumed that image projection apparatuses such as projectors will be used in various fields and for various purposes in the future. For example, it is assumed that large-screen display, high-brightness display, or the like using a plurality of image projection apparatuses will become widespread. Technologies capable of assisting the uses of such various image projection apparatuses have been demanded.

In view of the above circumstances, it is an object of the present technology to provide an information processing apparatus, an information processing method, and a program capable of substantially assisting the use of an image projection apparatus.

### Solution to Problem

In order to achieve the above object, an information processing apparatus according to an embodiment of the present technology includes an acquisition unit and a generation unit.

The acquisition unit acquires setting information regarding projection of an image by an image projection apparatus.

The generation unit generates a simulation image including a plurality of image projection apparatuses and respective display regions of a plurality of images projected by the plurality of image projection apparatuses on the basis of the acquired setting information.

In the information processing apparatus, a simulation image including a plurality of image projection apparatuses and respective display regions of a plurality of projected images is generated on the basis of setting information. Accordingly, it becomes possible to perform, for example, a simulation of large-screen display, high-brightness display, or the like by a plurality of projection apparatuses. As a result, it becomes possible to substantially assist the use of image projection apparatuses.

The setting information may include user setting information set by a user. In this case, the generation unit may generate the simulation image on the basis of the user setting information.

Thus, a user is allowed to perform a desired simulation.

The user setting information may include information of a type of the image projection apparatus.

Thus, it becomes possible to perform a high-accuracy simulation.

The user setting information may include information of a lens used in the image projection apparatus.

Thus, it becomes possible to perform a high-accuracy simulation.

The user setting information may include at least one of a position, an attitude, a lens shift amount, or an aspect ratio of an image of the image projection apparatus.

Thus, it becomes possible to perform a high-accuracy simulation.

The user setting information may include information of a blending width. In this case, the generation unit may generate the simulation image including a guide frame based on the information of the blending width.

Thus, it becomes possible to simulate blending of a plurality of images by a plurality of image projection apparatuses with high accuracy.

The user setting information may include a command to duplicate a first image projection apparatus in the simulation image. In this case, the generation unit may generate the simulation image including a second image projection apparatus duplicated at a same position as the first image projection apparatus according to the command.

Thus, it becomes easy to perform a simulation of blending, stacking, or the like of a plurality of images by a plurality of image projection apparatuses.

The user setting information may include information of space in which the plurality of image projection apparatuses are used. In this case, the generation unit may generate the simulation image including the space.

Thus, it becomes possible to perform a high-accuracy simulation.

The user setting information may include information of a projected object onto which the image is to be projected. In this case, the generation unit may generate the simulation image including the projected object.

Thus, it becomes possible to perform a high-accuracy simulation.

The information processing apparatus may further include: a storage unit that stores type setting information set for each type of the image projection apparatus. In this case, the acquisition unit may acquire the type setting information from the storage unit. In addition, the generation unit may generate the simulation image on the basis of the acquired type setting information.

Thus, it becomes possible to perform a high-accuracy simulation.

The type setting information may include information of an offset between a center of gravity of a housing of the image projection apparatus and a position of a virtual light source.

Thus, it becomes possible to perform a high-accuracy simulation.

The generation unit may generate the simulation image including a projected image that is an image projected by the image projection apparatus.

Thus, it becomes possible to simulate the appearance of an image projected onto a screen or the like with high accuracy.

The acquisition unit may acquire image information of an image selected by the user. In this case, the generation unit may generate the simulation image including the projected image on the basis of the acquired image information.

Thus, it becomes possible to simulate, for example, the appearance of a desired image projected onto a screen or the like with high accuracy.

The generation unit may be capable of changing transmittance of the projected image.

Thus, it becomes possible to simulate brightness or the like of a projected image projected onto a screen or the like with high accuracy.

The generation unit may be capable of changing the transmittance for each pixel of the projected image.

Thus, it becomes possible to simulate the distribution of the brightness of a projected image projected on a screen or the like with high accuracy.

The generation unit may determine the transmittance on the basis of at least one of a distance to the projected object onto which the projected image is to be projected, characteristics of the lens used in the image projection apparatus, or reflectance of the projected object.

Thus, it becomes possible to simulate the distribution or the like of the brightness of a projected image projected onto a screen or the like with high accuracy according to, for example, a condition in a case in which projection is actually performed.

The generation unit may generate the simulation image including distortion of the image projected by the image projection apparatus.

Thus, it becomes possible to perform a high-accuracy simulation in which distortion of an image caused by projection is reproduced.

The information processing apparatus may further include a determination unit that determines whether the distortion of the image is correctable. In this case, the generation unit may generate the simulation image including a notification image that notifies a determination result by the determination unit.

Thus, it becomes possible to properly perform a simulation while avoiding, for example, a setting under which distortion correction is not allowed.

The determination unit may determine whether the distortion of the image is correctable on the basis of at least one of the distortion of the image or information of a distortion correction function of the image projection apparatus.

Thus, it becomes possible to properly perform a simulation according to the characteristics of a projector or the like.

The generation unit may generate the simulation image including an image expressing a range in which the distortion of the image is correctable.

Thus, it becomes possible to easily perform a simulation according to, for example, a range in which the correction of a trapezoid or the like is allowed.

The user setting information may include a movement amount along a direction of a light axis of the image projection apparatus.

Thus, movement along a direction of a light axis can be, for example, simulated.

The user setting information may include a movement amount of movement based on a shape of the projected object onto which the image is to be projected.

Thus, it is possible to easily simulate the movement of a projector or the like according to the shape of a screen or the like.

The movement based on the shape of the projected object may be movement along the shape of the projected object.

Thus, it is possible to easily move a projector or the like along the shape of a screen or the like. Thus, it is possible to smoothly perform a simulation.

The movement based on the shape of the projected object may be movement in which an angle of the light axis of the image projection apparatus with respect to the projected object is maintained.

Thus, it is possible to easily move a projector while making a projected angle or the like with respect to a screen or the like constant. Thus, it is possible to smoothly perform a simulation.

The generation unit may generate the simulation image including a layout image expressing arrangement states of the plurality of image projection apparatuses based on the projected object onto which the image is to be projected.

Thus, it becomes possible to easily simulate an appropriate layout according to the shape of a screen or the like.

The user setting information may include information of the projected object and the number of the image projection apparatuses. In this case, the generation unit may generate the simulation image including the layout image on the basis of the information of the projected object and the number of the image projection apparatuses.

Thus, it becomes possible to easily simulate an appropriate layout according to the number of projectors or the like.

The generation unit may generate a setting image for setting the user setting information.

It becomes possible to easily input user setting information via a setting image.

When the user setting information that is invalid is input, the generation unit may generate the setting image in which the user setting information that is invalid is highlighted.

Thus, operability on the input of user setting information is improved.

An information processing method according to an embodiment of the present technology is an information processing method performed by a computer system, the method including acquiring setting information regarding projection of an image by an image projection apparatus.

A simulation image including a plurality of image projection apparatuses and respective display regions of a plurality of images projected by the plurality of image projection apparatuses is generated on the basis of the acquired setting information.

A program according to an embodiment of the present technology causes a computer system to perform the following steps. The steps include: a step of acquiring setting information regarding projection of an image by an image projection apparatus; and a step of generating a simulation image including a plurality of image projection apparatuses and respective display regions of a plurality of images projected by the plurality of image projection apparatuses on the basis of the acquired setting information.

### Advantageous Effects of Invention

According to the present technology, it becomes possible to substantially assist the use of an image projection apparatus as described above. Note that the effects described above are not limitative, but any effect described in the present disclosure may be produced.

### BRIEF DESCRIPTION OF DRAWINGS

FIG. 1 is a block diagram showing a hardware configuration example of an information processing apparatus according to an embodiment.

FIG. 2 is a block diagram showing a functional configuration example of the information processing apparatus according to the present embodiment.

FIG. 3 is a flowchart showing a basic operation example of the information processing apparatus.

FIG. 4 is a view showing a configuration example of an application image according to the present technology.

FIG. 5 is a table showing an example of first setting parameters on a room.

FIG. 6 is a view showing the configuration example of the second setting image for inputting the second setting parameters on the screen.

FIG. 7 is a view showing a configuration example of a second setting image for inputting second setting parameters on a screen.

FIG. 8 is a table showing an example of the second setting parameters.

FIG. 9 is a view showing a configuration example of a third setting image for inputting third setting parameters on a projector.

FIG. 10 is a view showing the whole of the third setting image.

FIG. 11 is a table showing an example of the third setting parameters.

FIG. 12 is a schematic view for describing a lens shift.

FIG. 13 is a view showing another configuration example of a simulation image.

FIG. 14 is a schematic view for describing a blending guide.

FIG. 15 is a view showing a configuration example of an apparatus addition image.

FIG. 16 is a view showing a simulation example of blending by a plurality of projectors.

FIG. 17 is a view showing a simulation example of the stacking of a plurality of images.

FIG. 18 is a view showing a simulation example of the stacking of a plurality of images.

FIG. 19 is a view showing a simulation example of the stacking of a plurality of images.

FIG. 20 is a view showing another example of a simulation by a plurality of projectors.

FIG. 21 is a view showing another example of a simulation by a plurality of projectors.

FIG. 22 is a table showing an example of other user setting parameters.

FIG. 23 is a table showing an example of projector parameters stored in a storage unit.

FIG. 24 is a schematic view for describing the projector parameters.

FIG. 25 is a schematic view for describing the projector parameters.

FIG. 26 is a schematic view for describing the projector parameters.

FIG. 27 is a view showing a simulation example of image projection onto a three-dimensional projected object.

FIG. 28 is a view showing a configuration example of a list image of a simulation result.

FIG. 29 is a table showing an example of output parameters displayed in the list image.

FIG. 30 is a view showing a configuration example of a description image for describing the output parameters.

FIG. 31 is a view showing a configuration example of a description image for describing the output parameters.

FIG. 32 is a view for describing an error display.

FIG. 33 is a schematic view for describing an example of a simulation image according to a second embodiment.

FIG. 34 is a diagram showing an example of a simulation image according to a third embodiment.

FIG. 35 is a view showing an example of a notification image for notifying a determination result by a determination unit.

FIG. 36 is a schematic view for describing an example of a simulation image according to a fourth embodiment.

FIG. 37 is a schematic view for describing an example of a simulation image according to a fifth embodiment.

FIG. 38 is a flowchart showing an example of calculating the layout of a plurality of projectors.

FIG. 39 is a schematic view for describing the flowchart shown in FIG. 38.

FIG. 40 is a schematic view for describing a case in which the layout of another projection mode is calculated.

FIG. 41 is a schematic view showing an example of a layout image about a curve-shaped screen.

FIG. 42 is a view showing another configuration example of an application image.

### MODE(S) FOR CARRYING OUT THE INVENTION

Hereinafter, embodiments according to the present technology will be described with reference to the drawings.

[Configuration of Information Processing Apparatus]

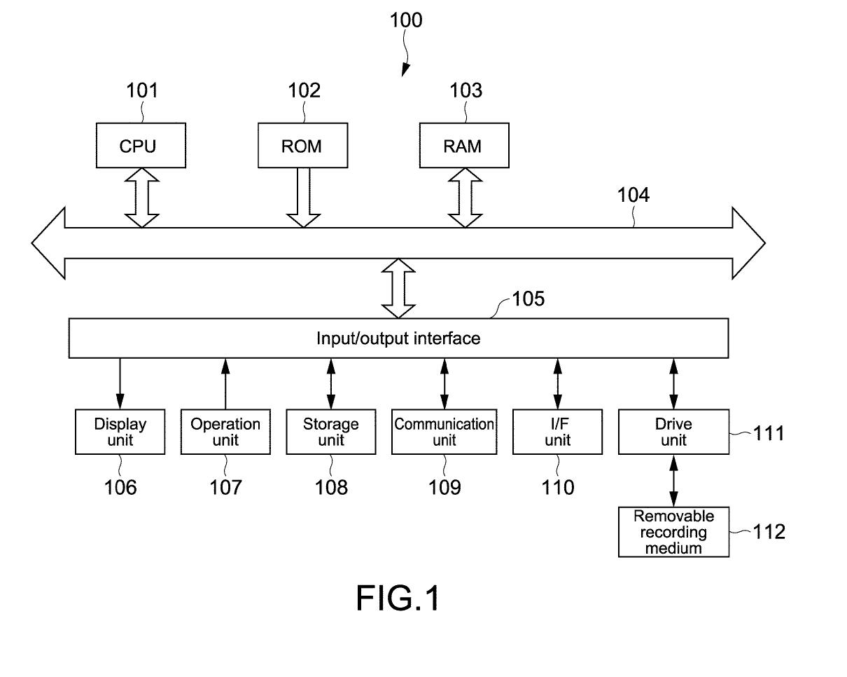

FIG. 1 is a block diagram showing a hardware configuration example of an information processing apparatus according to an embodiment of the present technology. As the information processing apparatus, any computer such as a PC (Personal Computer) may be, for example, used.

An information processing apparatus 100 includes a CPU (Central Processing Unit) 101, a ROM (Read Only Memory) 102, a RAM (Random Access Memory) 103, an input/output interface 105, and a bus 104 that connects these parts to each other. To the input/output interface 105 are connected a display unit 106, an operation unit 107, a storage unit 108, a communication unit 109, an I/F (interface) unit 110, a drive unit 111, and the like.

The display unit 106 is, for example, a display device using a liquid crystal, EL (Electro-Luminescence), or the like. The operation unit 107 is, for example, a keyboard, a pointing device, a touch panel, or another operation device. When the operation unit 107 includes a touch panel, the touch panel can be integrated with the display unit 106.

The storage unit 108 is a non-volatile storage device and is, for example, a HDD (Hard Disk Drive), a flash memory, or another solid-state memory. The drive unit 111 is, for example, a device capable of driving a removable recording medium 112 such as an optical recording medium and a magnetic recording tape.

The communication unit 109 is a communication module for communicating with other devices via a network such as a LAN (Local Area Network) and a WAN (Wide Area Network). A communication module for short-distance wireless communication such as Bluetooth™ may be provided. In addition, communication equipment such as a modem and a router may be provided.

The I/F unit 110 is an interface to which other devices or various cables such as a USB (Universal Serial Bus) terminal and a HDMI™ (High-Definition Multimedia Interface) terminal are connected. The display unit 106, the operation unit 107, the communication unit 109, or the like may be connected to the information processing apparatus 100 via the I/F unit 110.

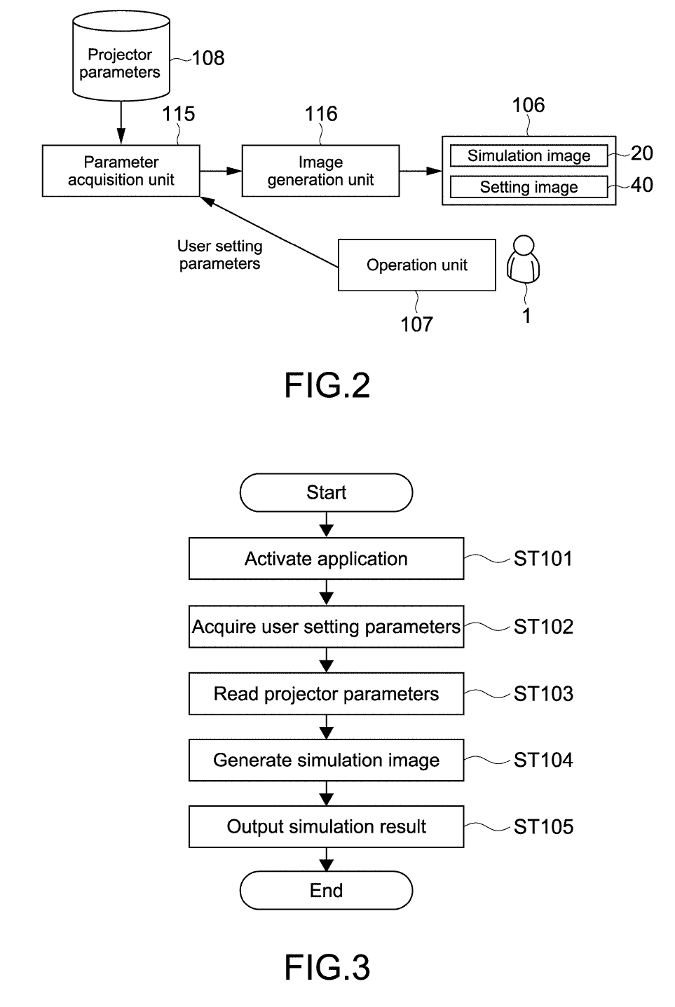

Information processing by the information processing apparatus 100 is realized, for example, when the CPU 101 loads a prescribed program stored in the ROM 102, the storage unit 108, or the like into the RAM 103 and performs the same. In the present embodiment, a parameter acquisition unit 115 and an image generation unit 116 (see FIG. 2) are configured when the CPU 101 performs a prescribed program according to the present technology, and an information processing method according to the present technology is performed. Note that dedicated hardware may be used to realize respective blocks.

Programs are installed in the information processing apparatus 100 via, for example, various recording media. Alternatively, the programs may be installed in the information processing apparatus 100 via the Internet or the like.

[Basic Operation of Information Processing Apparatus]

FIG. 2 is a block diagram showing a functional configuration example of the information processing apparatus 100 according to the present embodiment. FIG. 3 is a flowchart showing a basic operation example of the information processing apparatus 100.

First, an application for providing a simulation service according to the present technology is activated by a user 1 (step 101). The operation unit 107 is operated by the user 1 to input user setting parameters via a setting image 40 displayed on the display unit 106. The input user setting parameters are acquired by a parameter acquisition unit 115 (step 102).

Projector parameters stored in the storage unit 108 are acquired by the parameter acquisition unit 115 (step 103). As user setting information, the type information of a projector desired to perform a simulation is, for example, input. The parameter acquisition unit 115 reads from the storage unit 108 projector parameters stored in association with the type information.

The acquired user setting parameters and the projector parameters are output to the image generation unit 116. On the basis of the user setting parameters and the projector parameters, the image generation unit 116 generates a simulation image 20 (step 104). The generated simulation image 20 is output to the display unit 106 as a simulation result (step 105). Note that the simulation result includes output parameters that will be described later.

The user 1 is allowed to change the user setting parameters while confirming the simulation image displayed on the display unit 106. As the parameter acquisition unit 115 and the image generation unit 116 operate according to a change in the user setting parameters, the simulation image 20 displayed on the display unit 106 is also changed. Thus, it becomes possible to perform a desired simulation with high accuracy.

Note that the projector corresponds to an image projection apparatus in the present embodiment. The parameter acquisition unit 115 and the image generation unit 116 correspond to an acquisition unit and a generation unit, respectively. The user setting parameters and the projector parameters correspond to user setting information and type setting information, respectively. These information items are included in setting information regarding the projection of an image by the image projection apparatus.

[Specific Contents of Simulation Service]

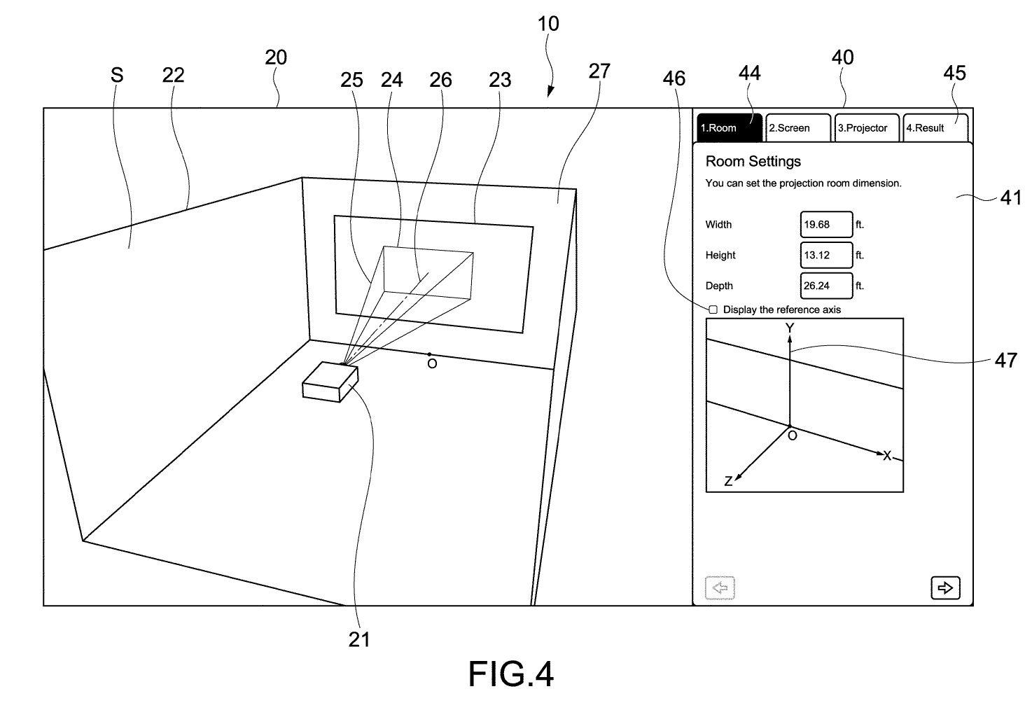

FIG. 4 is a view showing a configuration example of an application image according to the present technology. An application image 10 has a simulation image 20 and a setting image 40.

The simulation image 20 includes a projector 21, a room (hall) 22 constituting space S in which the projector 21 is used, a screen 23 serving as a projected object onto which an image is to be projected, and a display region 24 of a projected image. The display region 24 corresponds to the contour of a projected image. In addition, in the present embodiment, a light beam 25 projected from the projector 21 and a light axis 26 of the projector 21 are also displayed.

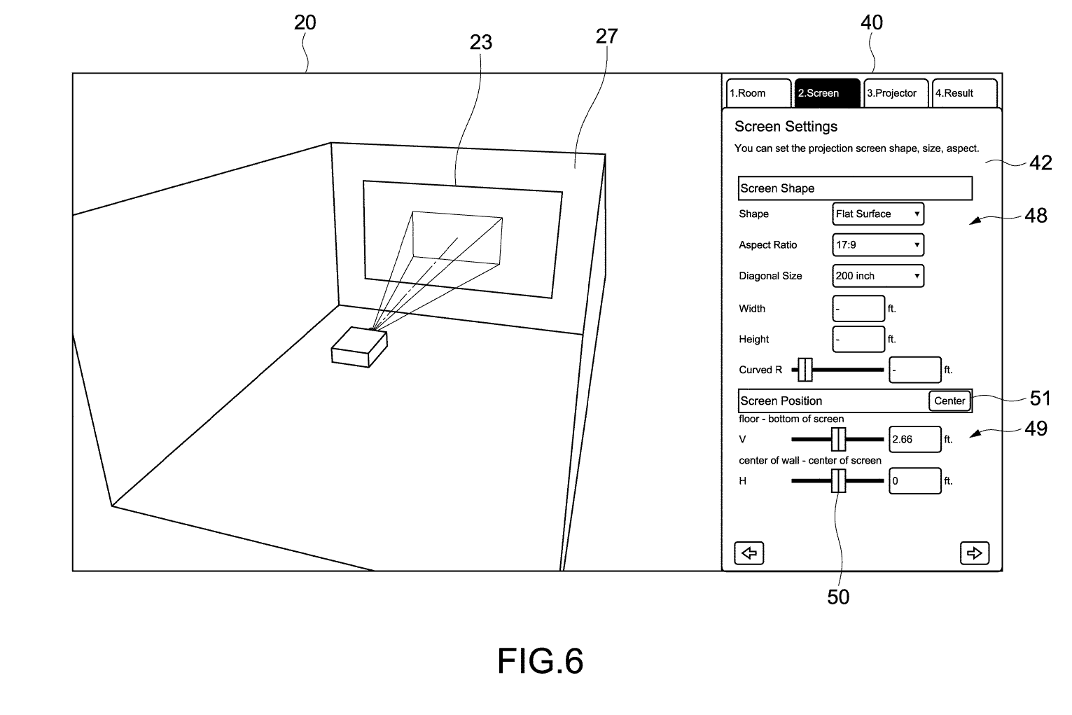

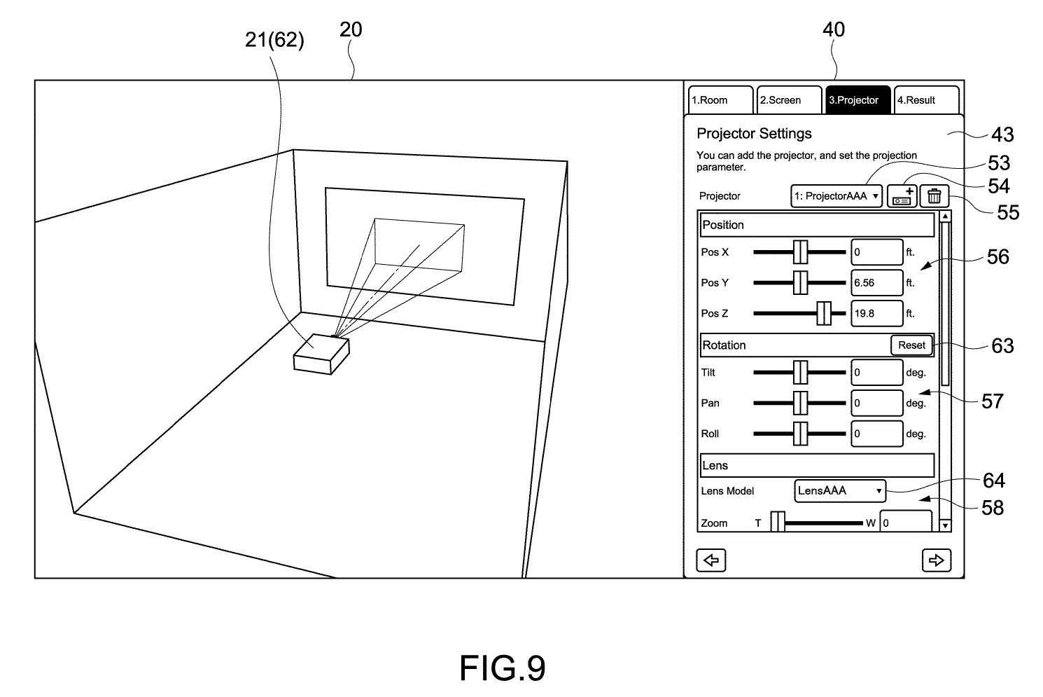

The setting image 40 includes first to third setting images 41, 42, and 43 (see FIG. 6, FIG. 9, or the like) for inputting first to third setting parameters on the room 22, the screen 23, and the projector 21, respectively. The first to third setting images 41, 42, and 43 are displayed to be made switchable by the selection of setting tabs 44 shown in FIG. 4.

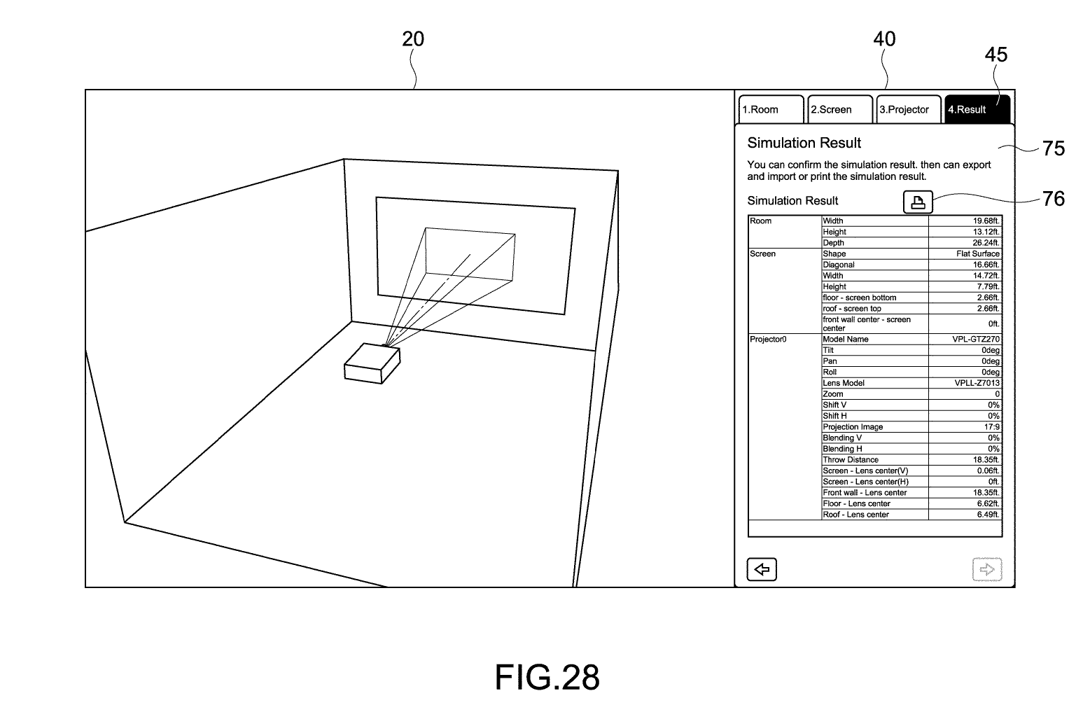

In addition, in the present embodiment, the application image 10 includes a list image 75 of a simulation result (see FIG. 28). The list image 75 is displayed to be made switchable with the respective setting images 41 to 43 by the selection of a result display tab 45 shown in FIG. 4. Output parameters displayed in the list image 75 as a simulation result will be described later.

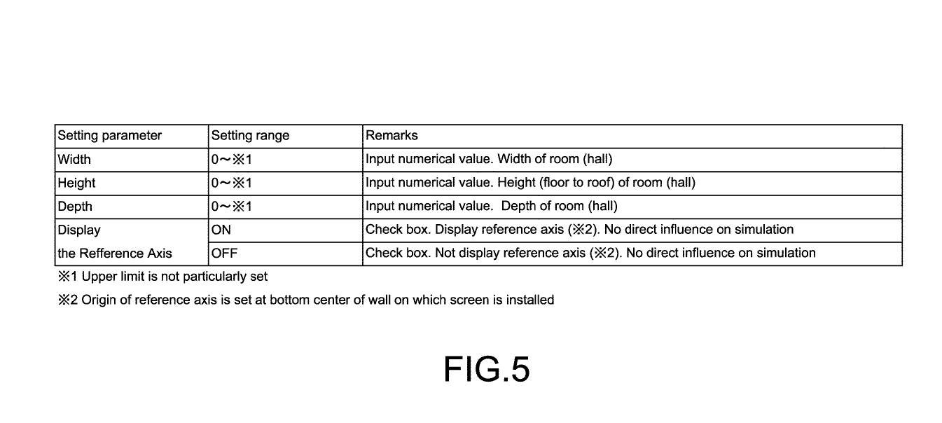

In FIG. 4, the first setting image 41 for inputting the first setting parameters on the room 22 is displayed. FIG. 5 is a table showing an example of the first setting parameters.

In the present embodiment, it is possible to input the width, the height, and the depth of the room 22 as the first setting parameters. The room 22 constituting the space S having sizes corresponding to these input parameters is three-dimensionally displayed in the simulation image 20. It is possible to display a view of the space S and the room 22 in an arbitrary three-dimensional direction and appropriately change the direction through, for example, a drug operation or the like. Thus, a high-accuracy simulation can be performed.

Note that the units of the sizes are not limited but any unit such as cm, inch, and feet may be used. In the present embodiment, the width, the height, and the depth of the room 22 correspond to the information of space in which the image projection apparatus is used.

By putting a check mark in a check box 46 shown in FIG. 4, it is possible to display an XYZ reference axis 47 in the simulation image 20. The reference axis 47 is an axis based on which the settings of the positions (coordinates) of the projector 21, the screen 23, or the like are made.

An origin O of the reference axis 47 is set at the center of the lower side of an installation surface 27 on which the screen 23 is installed. Of course, the origin O is not limited to this position. The origin O is shown in the simulation image 20 to facilitate the understanding of the positional relationship of the reference axis 47 in FIG. 4 but is not actually displayed.

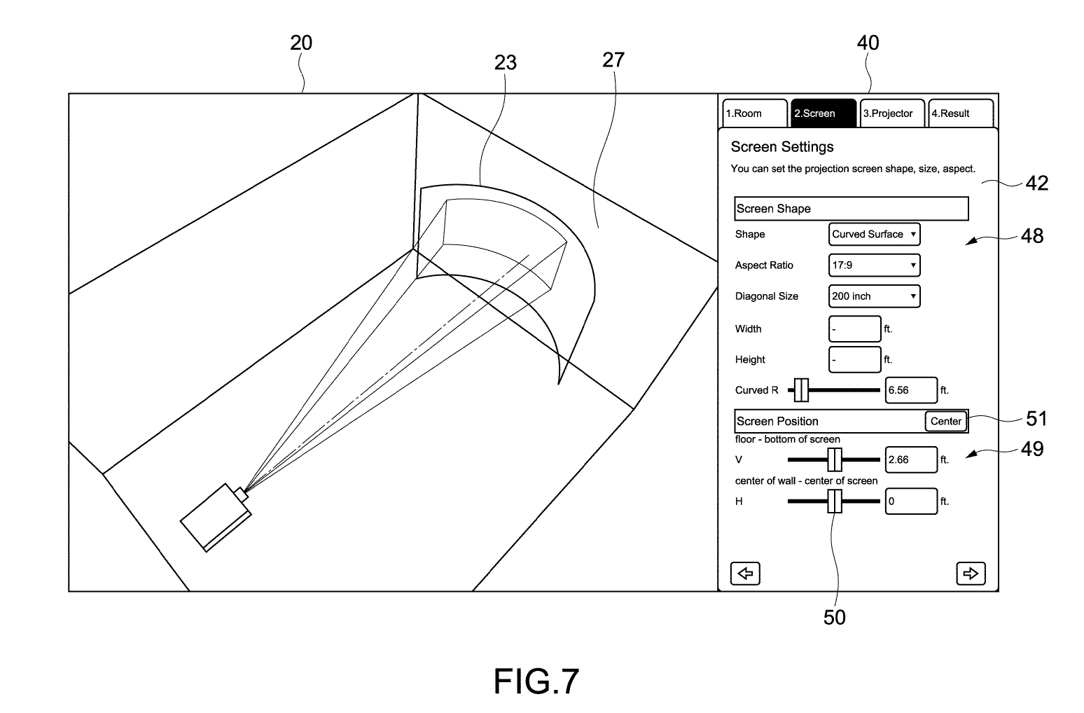

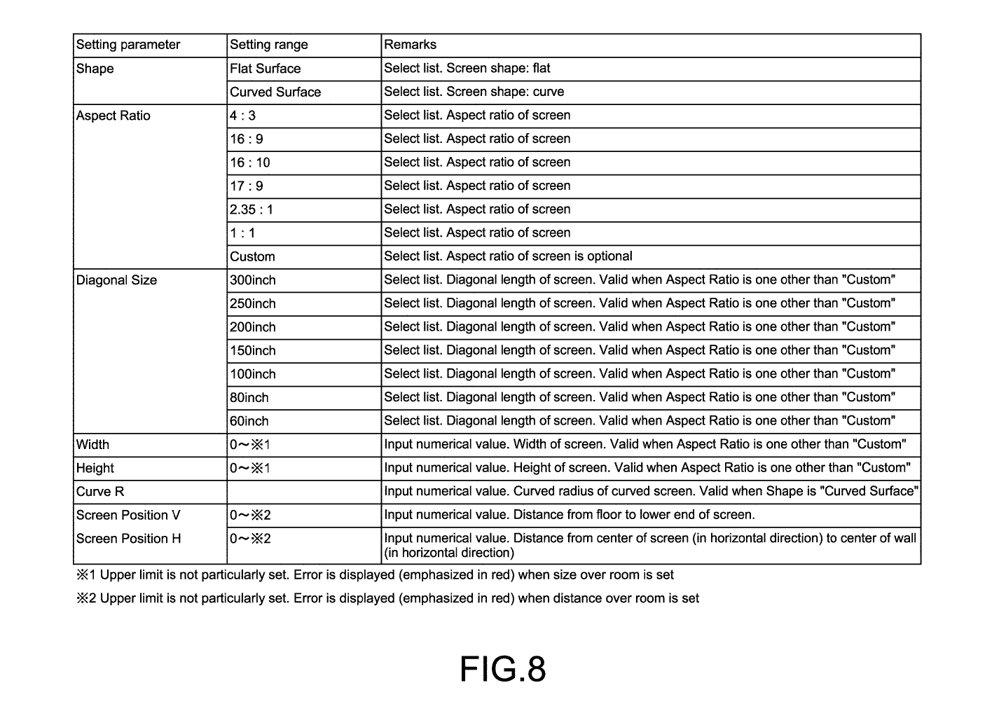

FIGS. 6 and 7 are views showing a configuration example of the second setting image 42 for inputting the second setting parameters on the screen 23. FIG. 8 is a table showing an example of the second setting parameters.

The second setting image 42 includes a shape input unit 48 and a position input unit 49. In the present embodiment, it is possible to input the shape, the aspect ratio, the sizes, and the position of the screen 23 as the second setting parameters via the shape input unit 48 and the position input unit 49. The screen 23 corresponding to these parameters is displayed in the simulation image 20.

In an example shown in FIG. 6, a flat surface shape is selected as the shape of the screen 23, and a diagonal size is input as the size of the screen 23. In this case, the inputs of the width, the height, and the curvature radius of the screen 23 are not allowed. When the customization of the diagonal size is selected, it becomes possible to input the width and the height of the screen 23. Note that as for parameters not allowed to be input, their characters or input windows may be displayed in a different color such as gray (for example, a pale color) to easily understand the parameters not allowed to be input.

When a curved surface shape is selected as the shape of the screen 23, the screen 23 having the curved surface shape is displayed as shown in FIG. 7. In addition, when the parameter of the curvature radius is changed, the shape of the screen 23 in the simulation image 20 is changed.

The input of a screen position is allowed by the operation of sliders 50 in the position input unit 49 or by the direct input of numerical values. The same applies to other parameters. Note that when a center button 51 in the position input unit 49 shown in FIGS. 6 and 7 is selected, the position of the screen 23 is set so that the center of the screen 23 is aligned with the center of the installation surface 27. An error display shown in FIG. 8 will be described later.

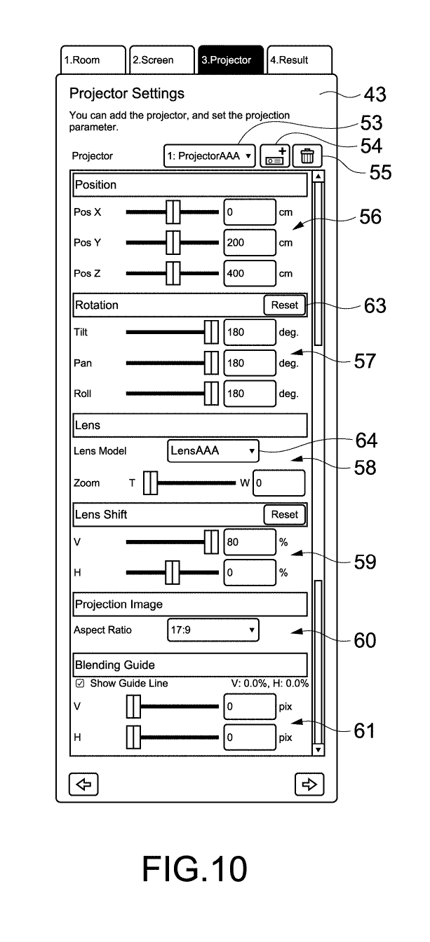

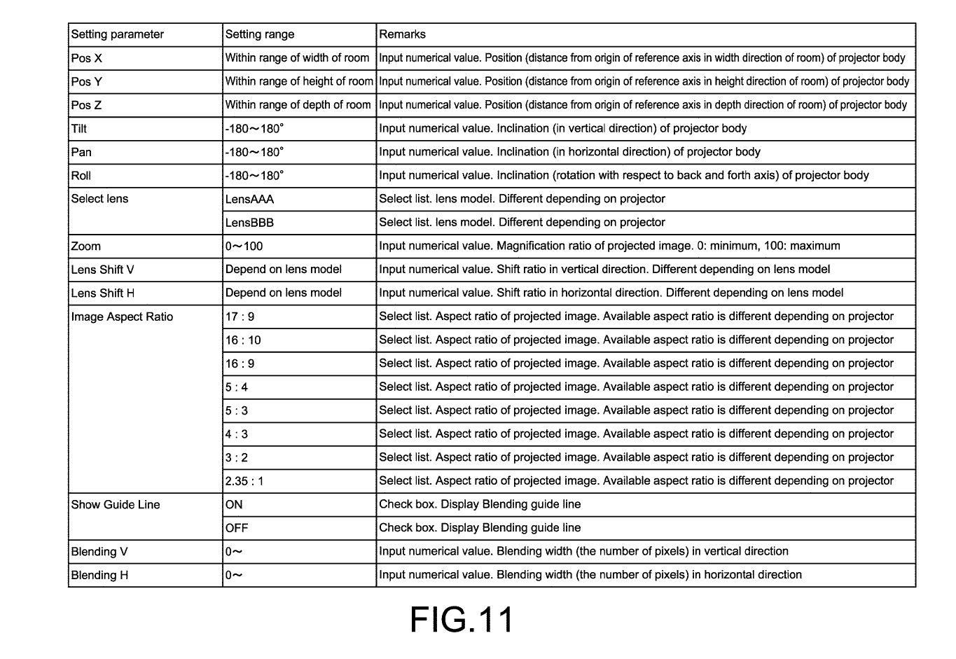

FIG. 9 is a view showing a configuration example of the third setting image 43 for inputting the third setting parameters on the projector 21. FIG. 10 is a view showing the whole of the third setting image 43. FIG. 11 is a table showing an example of the third setting parameters.

As shown in FIGS. 9 and 10, the third setting image 43 includes a type selection button 53, an apparatus addition button 54, an apparatus deletion button 55, a position input unit 56, an attitude input unit 57, a lens selection unit 58, a lens shift amount input unit 59, an aspect ratio input unit 60, and a blending guide input unit 61.

From a pulldown menu appearing after the selection of the down arrow of the type selection button 53, the projector 21 desired to perform a simulation can be selected. In the present embodiment, the type of the projector 21 is set by default, and the type (Projector AAA) is displayed. When the type is changed by the user 1, the projector 21 in the simulation image 20 is changed to another type.

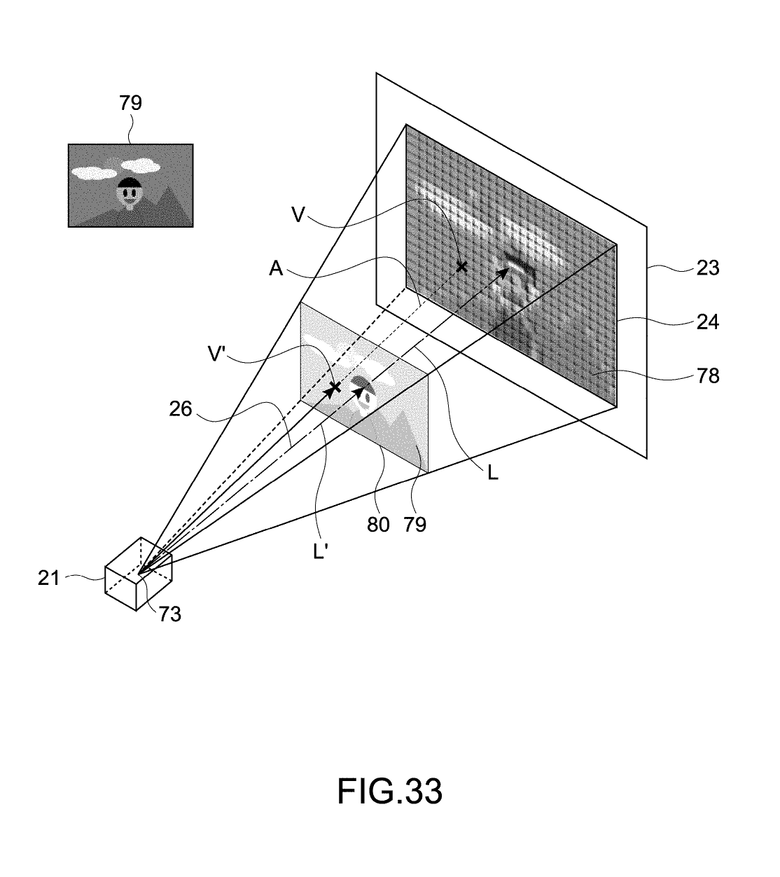

Note that the selection of the type of the projector 21 is not limited to selection by the type selection button 53 but may be changed, for example, by clicking the projector 21 in the simulation image 20 or may be changed from a parameter display image 220 in FIG. 33.

It is possible to input the position of the projector 21 via the position input unit 56. In the present embodiment, the center of gravity of a housing 62 of the projector 21 is arranged at the position of an input numerical value. The center of the gravity is stored or calculated as a value unique to each type of the projector 21.

It is possible to input the respective angles of a tilt, a pan, and a roll via the attitude input unit 57. As shown in FIG. 11, the tilt is an inclination in a vertical direction, and the pan is an inclination in a horizontal direction. In addition, the roll is an inclination based on a back and forth axis (Z-axis). Note that it is possible to reset input parameters by the selection of a reset button 63. The same applies to the input of a lens shift amount.

It is possible to select a lens model by a lens selection button 64 in the lens selection unit 58. In addition, it is also possible to input a zoom magnification that is the magnification ratio of a projected image. Note that the lens model corresponds to the information of a lens used in the image projection apparatus in the present embodiment.

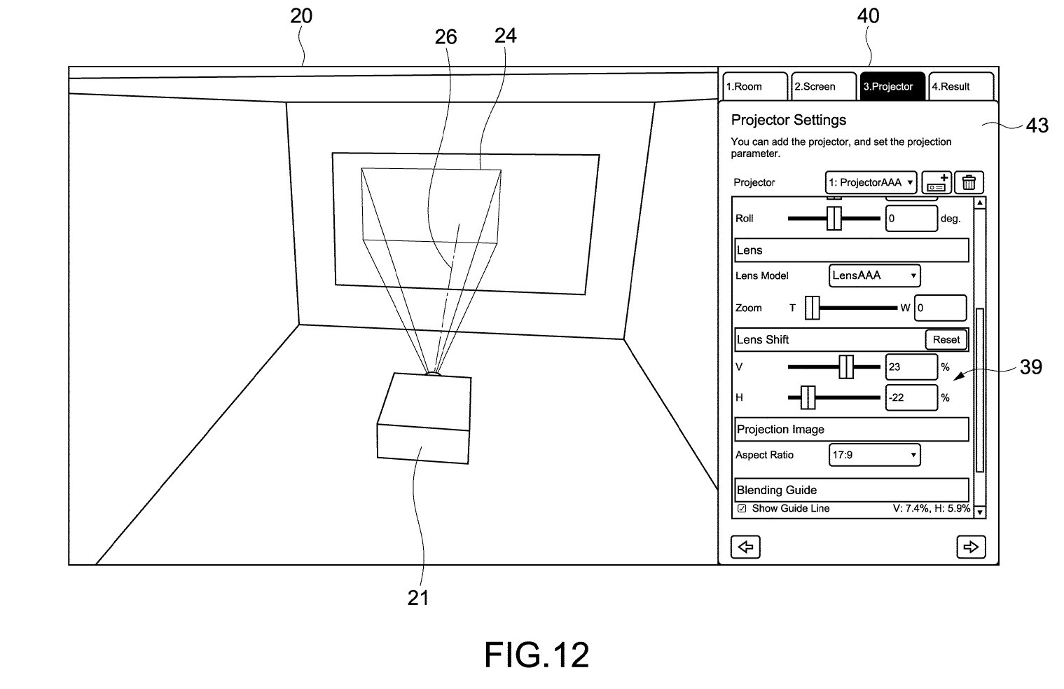

FIG. 12 is a schematic view for describing a lens shift. When a lens shift amount is input via a lens shift amount input unit 39, the position of the display region 24 of an image is shifted. The lens shift amount is capable of being set in each of a vertical direction (Y-axis direction) and a horizontal direction (X-axis direction). When the lens shift amount is zero in each of the vertical direction and the horizontal direction, the light axis 26 is positioned at the center of the display region 24. When the lens is shifted, the display region 24 moves with respect to the light axis 26.

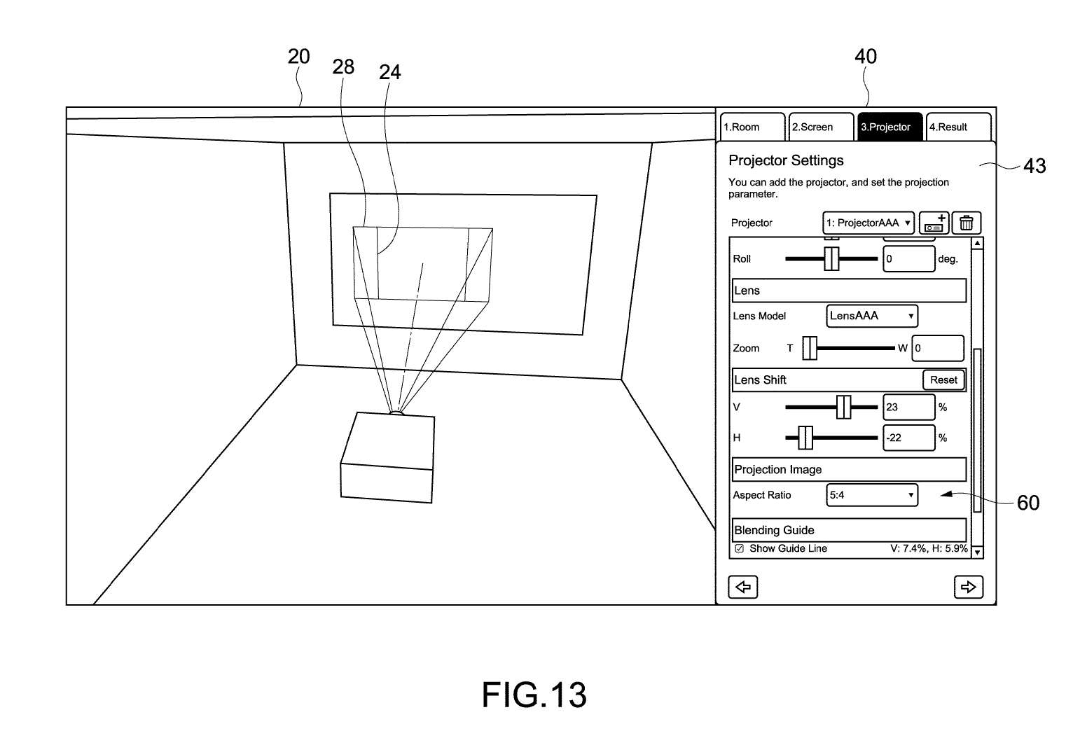

It is possible to input the aspect ratio of a projected image via the aspect ratio input unit 60. The size of the display region 24 is changed according to an input aspect ratio. Note that both a projected region 28 (having an aspect ratio of, for example, 17:9) in which light is to be projected and the display region 24 (having an aspect ratio of, for example, 5:4) of an image may be displayed as shown in FIG. 13. In this case, a region constituting the image corresponds to the display region 24 of the image.

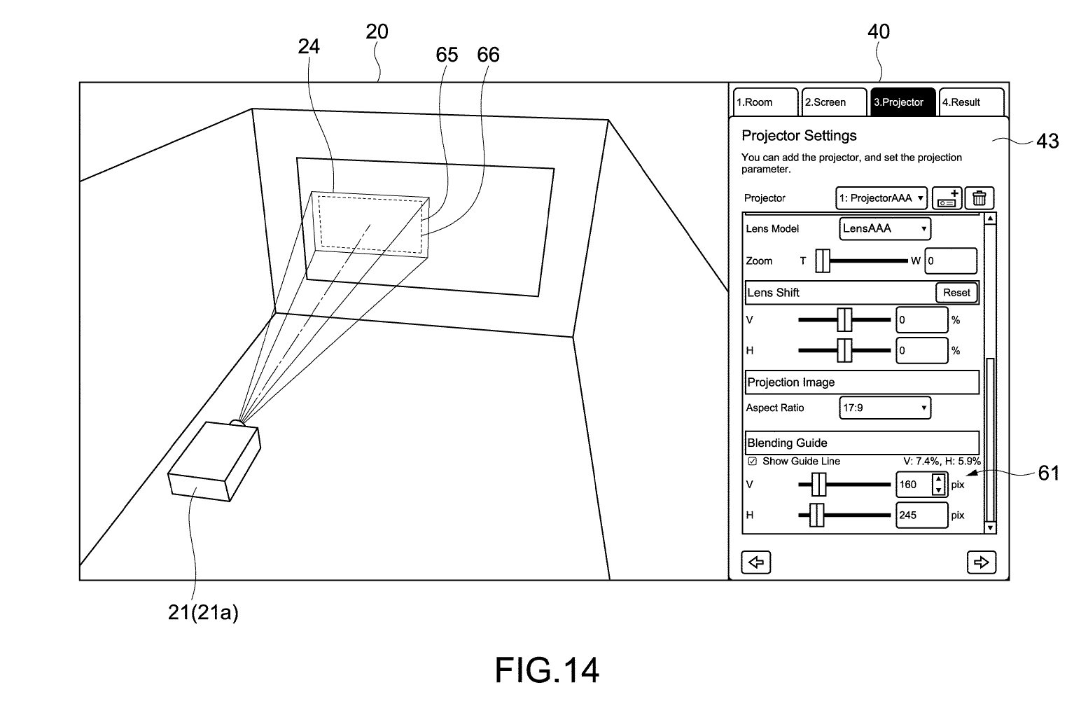

FIG. 14 is a schematic view for describing a blending guide. As a method for performing large-screen display with a plurality of projectors, there has been known a method that is so-called blending in which a plurality of images are displayed to be partially stacked with each other and a stacked region is subjected to blending processing.

As shown in FIG. 14, it is possible to input a blending width on a pixel-by-pixel basis (pixel unit) in each of the vertical direction and the horizontal direction with the blending guide input unit 61 in the present embodiment. The blending width is the width of the blending region 65 stacked with another combined image. On the basis of the size of an input blending width, a blending guide 66 indicating the inside end of the blending region 65 is displayed (a size from the end of the display region 24 to the blending guide 66 corresponds to the blending width).

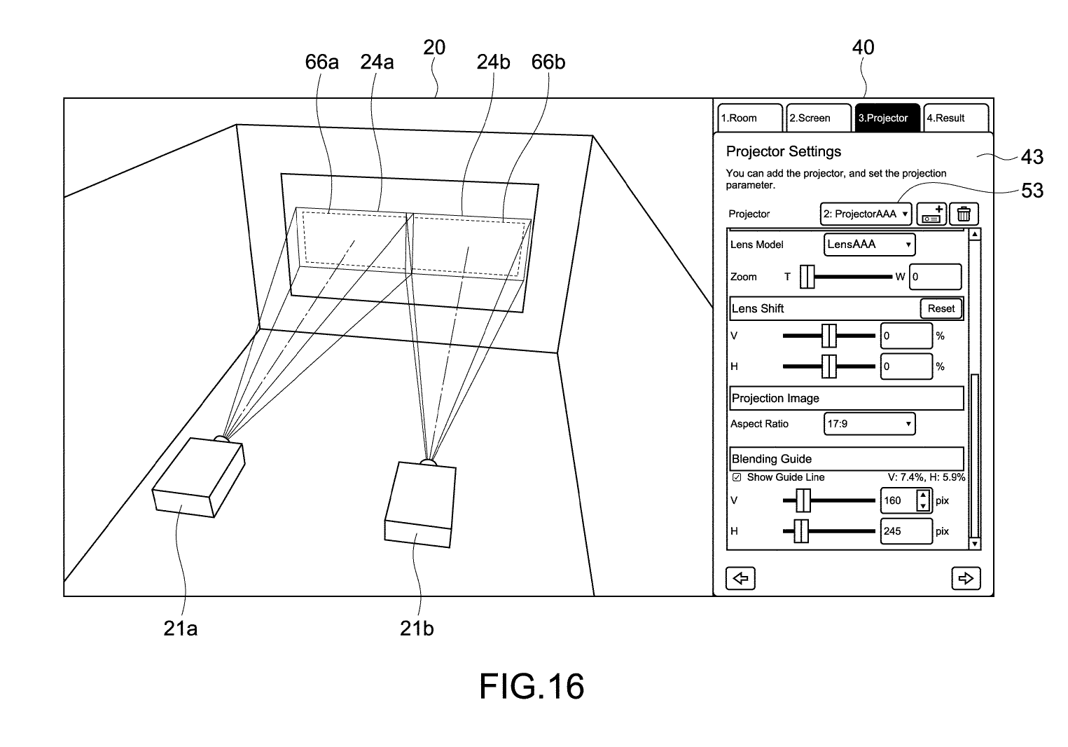

By the display of the blending guide 66 like this, it becomes possible to simulate the blending of a plurality of images with a plurality of projectors 21 with high accuracy (see FIG. 16). Note that it may be possible to input a different blending width in each of the vertical and horizontal positions of an image (display region 24). The blending guide 66 corresponds to a guide frame in the present embodiment.

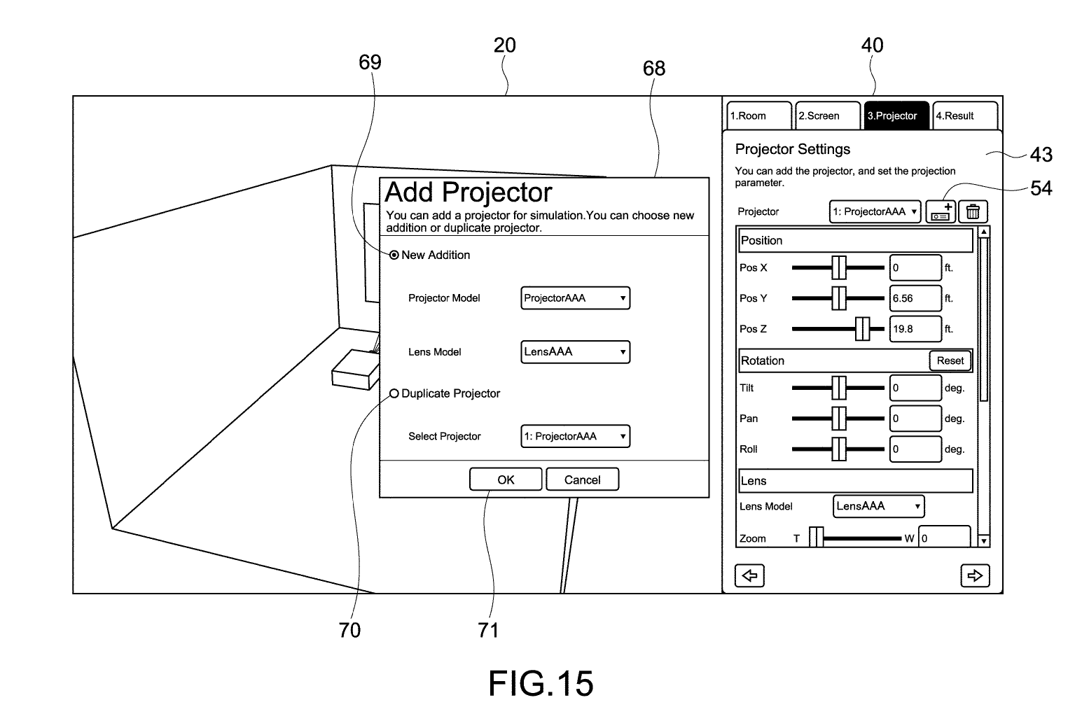

FIG. 15 is a view showing a configuration example of an apparatus addition image. When the apparatus addition button 54 in the third setting image 43 is selected, an apparatus addition image 68 is displayed. The apparatus addition image 68 includes a radio button 69 for new addition and a radio button 70 for duplicate function. When the radio button 69 for new addition is selected, the type of a projector 21 desired to be newly added and a lens model are selected. When an OK button 71 is then selected, the new projector 21 is displayed in the simulation image 20. On this occasion, the position of the projector 21 is, for example, a position set by default.

The duplicate function is a function by which a first projector having been displayed in the simulation image 20 is duplicated and displayed as a second projector. The duplicated second projector is duplicated at the same position as that of the first projector in a state of taking over various settings.

When the radio button 70 for duplicate function in the apparatus addition image 68 is selected, a projector 21 (that serves as a first projector) to be duplicated is selected. When the OK button 71 is selected, a second projector is displayed at the position of the first projector. The selection of the radio button 70 for duplicate function corresponds to a command to duplicate a first image projection apparatus.

FIG. 16 is a view showing a simulation example of blending by a plurality of projectors 21. For example, the projector 21 shown in FIG. 14 is selected as a first projector 21a, and the duplicate function is performed. As shown in FIG. 16, a duplicated second projector 21b is moved along the horizontal direction via the position input unit 56. On this occasion, the type selection button 53 displays the type name of the second projector 21b to be operated and the number two indicating the second projector 21. It is possible to change the projector 21 to be operated by, for example, the operation of the type selection button 53 or the like.

In a simulation image 20, a display region 24a of the first projector 21a and a blending guide 66a in the display region 24a are displayed. In addition, a display region 24b of the second projector 21b and a blending guide 66b in the display region 24b are displayed. Since various settings are taken over by the duplicate function, the sizes of the display regions 24a and 24b are equal to each other and the sizes of the blending guides 66a and 66b are also equal to each other.

The second projector 21b is moved so that the left end of the display region 24b of the second projector 21b is stacked with the right end of the blending guide 66a of the first projector 21a. Since blending widths are equal to each other, the right end of the display region 24a of the first projector 21a is stacked with the left end of the blending guide 66b of the second projector 21b. That is, the second projector 21b is moved to a position at which mutual projected images are properly combined with each other. By the use of the duplicate function like this, it becomes really easy to simulate the blending of a plurality of images.

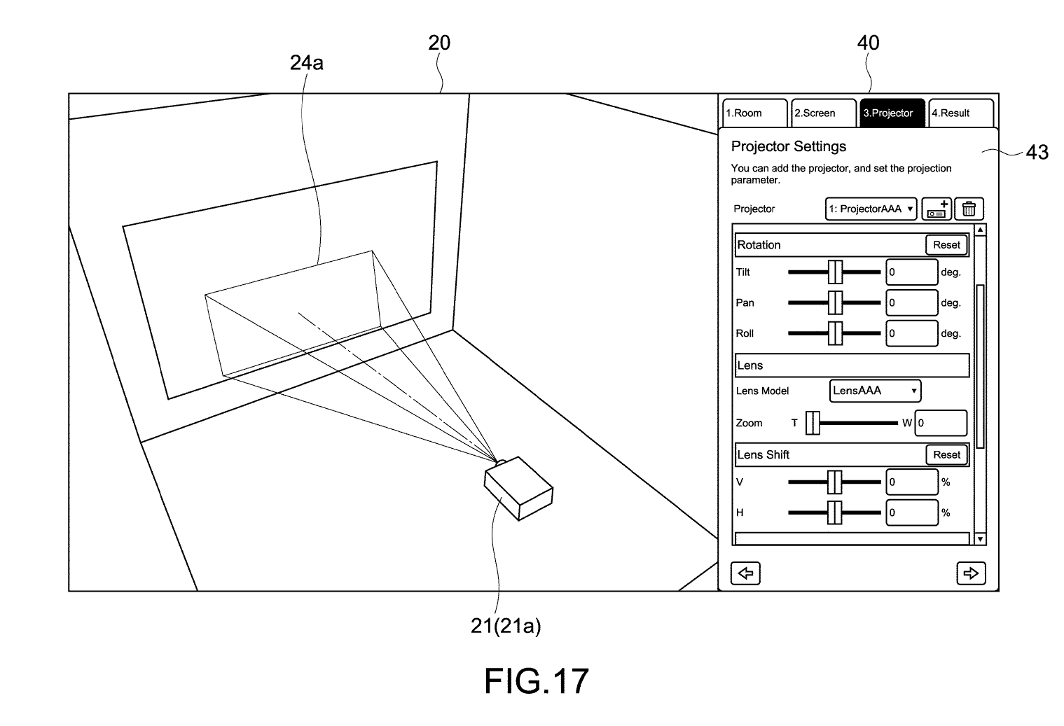

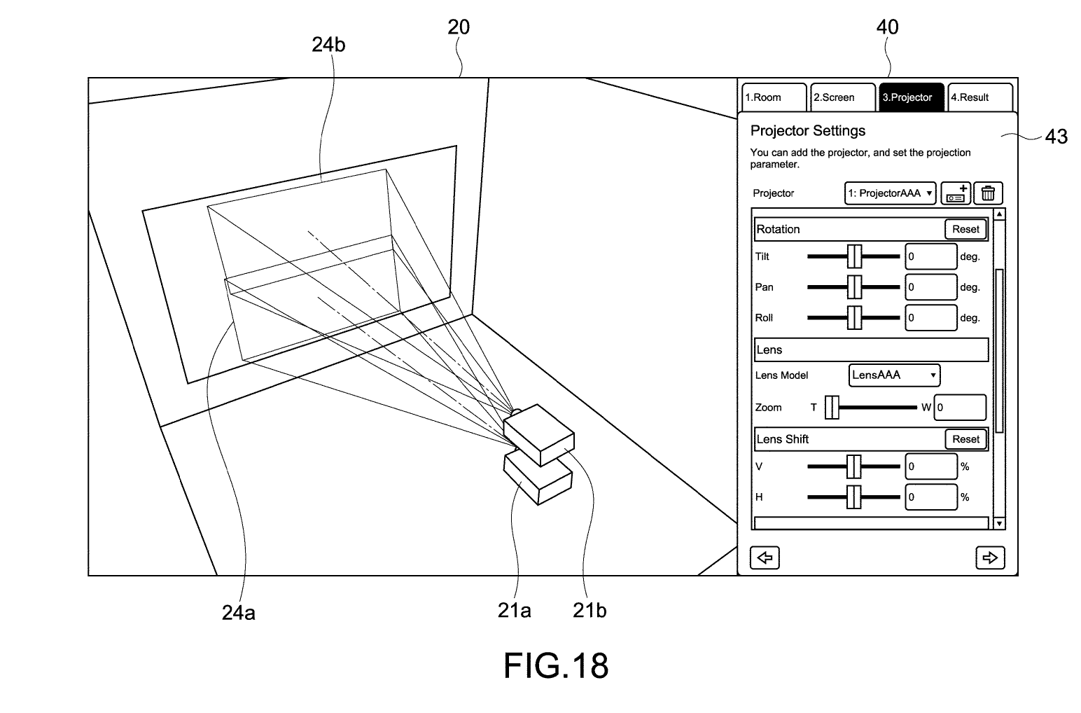

FIGS. 17 to 19 are views showing a stacking simulation example of projecting a plurality of images in a stacked state. For example, a projector 21 shown in FIG. 17 is selected as a first projector 21a, and the duplicate function is performed. As shown in FIG. 18, a duplicated second projector 21b is moved along the vertical direction.

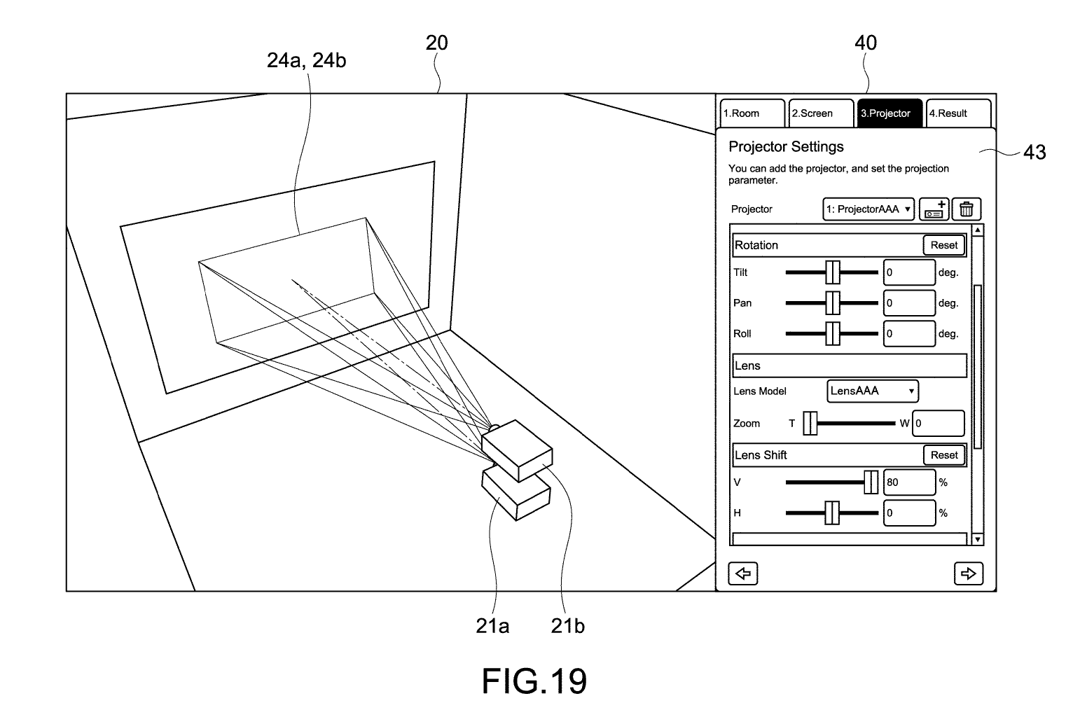

As shown in FIG. 19, a lens shift is performed along the vertical direction for each of the first and second projectors 21a and 21b. Thus, it becomes possible to easily stack mutual display regions 24a and 24b with each other. That is, by the use of the duplicate function, it becomes possible to really easily simulate the stacking of images. Note that the stacking of images is not limited to a case in which the whole regions of display regions 24 are stacked with each other but can include a case in which the display regions 24 are partially stacked with each other. In this case, it is also possible to easily perform a simulation with high accuracy.

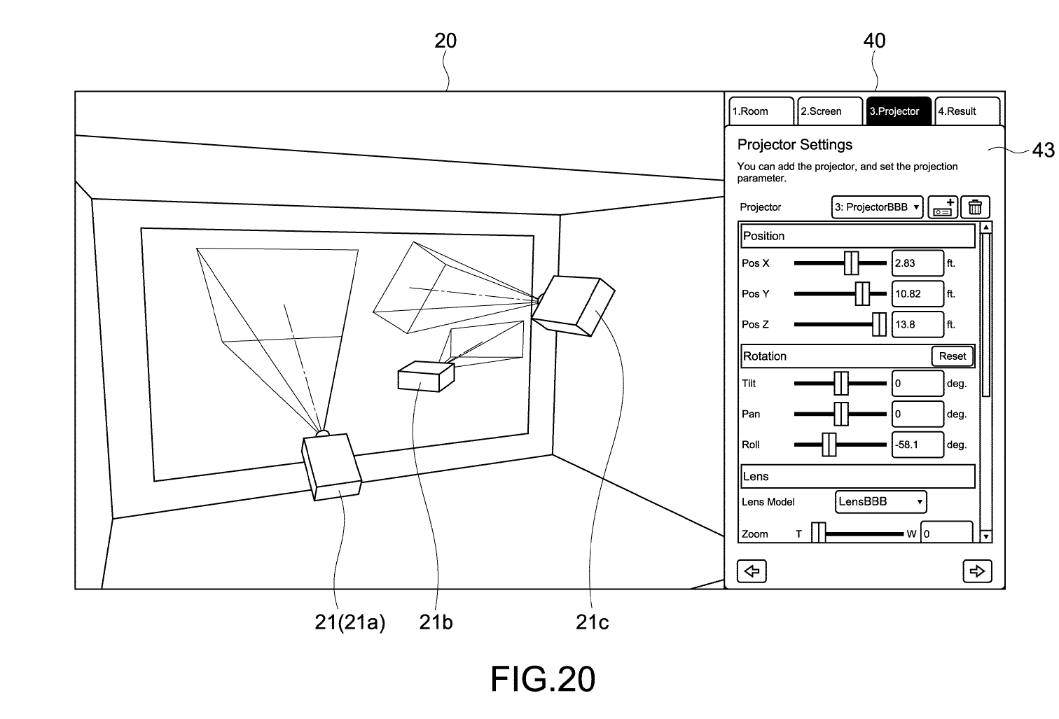

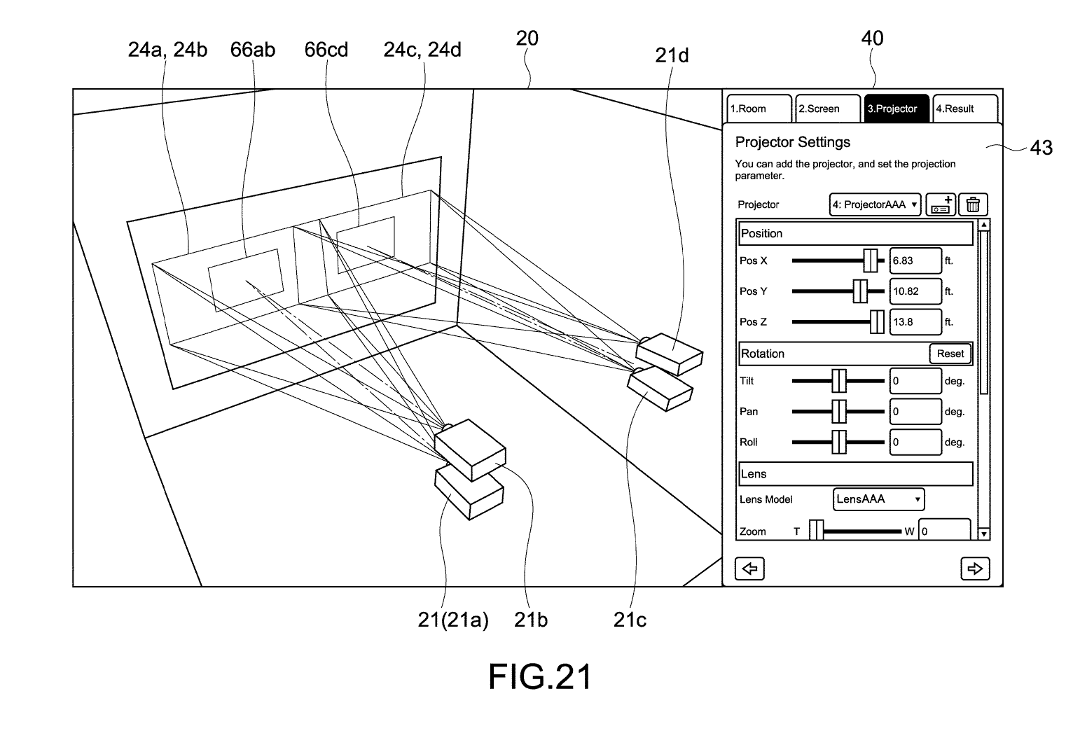

FIGS. 20 and 21 are views showing other examples of simulations by a plurality of projectors 21. As shown in FIG. 20, three projectors 21a, 21b, and 21c can be displayed by the use of the new addition function or the duplicate function. Further, the various parameters of positions, attitudes, or the like can be freely set for the respective projectors 21. Thus, it becomes possible to simulate various photographing conditions with high accuracy. Note that the number of projectors 21 capable of being simultaneously simulated is not limited but it is also possible to display four or more projectors 21.

As shown in FIG. 21, blending and stacking may be performed simultaneously. That is, images of projectors 21a and 21b are stacked with each other to display a high brightness image. In a simulation image 20, respective display regions 24a and 24b of the projectors 21a and 21b are displayed in a stacked state. In the display regions 24a and 24b, a blending guide 66ab is displayed.

Meanwhile, images of projectors 21c and 21d are also stacked with each other. In the simulation image 20, display regions 24c and 24d of the projectors 21c and 21d are displayed in a stacked state. A blending guide 66cd is displayed in the display regions 24c and 24d. The two display regions (four display regions 24a to 24d) are combined with each other on the basis of the blending guides 66ab and 66cd. Even when blending and stacking are simultaneously performed as described above, it is possible to perform a simulation with high accuracy.

The apparatus deletion button 55 is used at the time of deleting a projector 21 in a simulation image 20. When a projector 21 to be deleted is specified and the apparatus deletion button 55 is selected, the specified projector 21 is deleted.

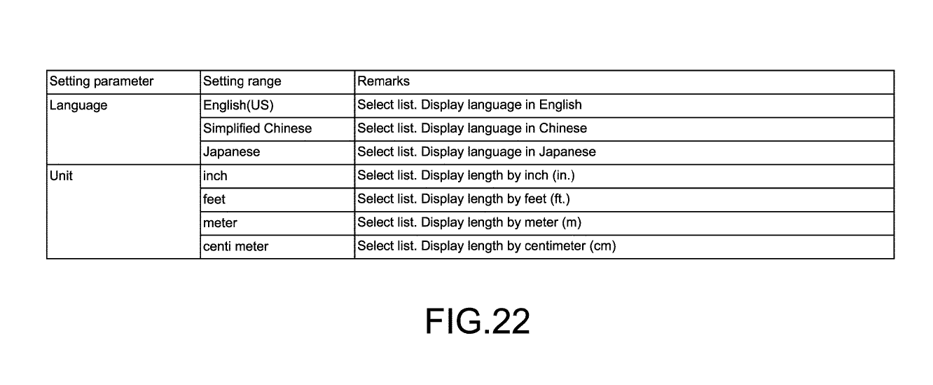

FIG. 22 is a table showing an example of other user setting parameters. For example, it may also be possible to input a use language or the unit of length as a configuration. An operation for setting the configuration is not limited but may be arbitrarily set.

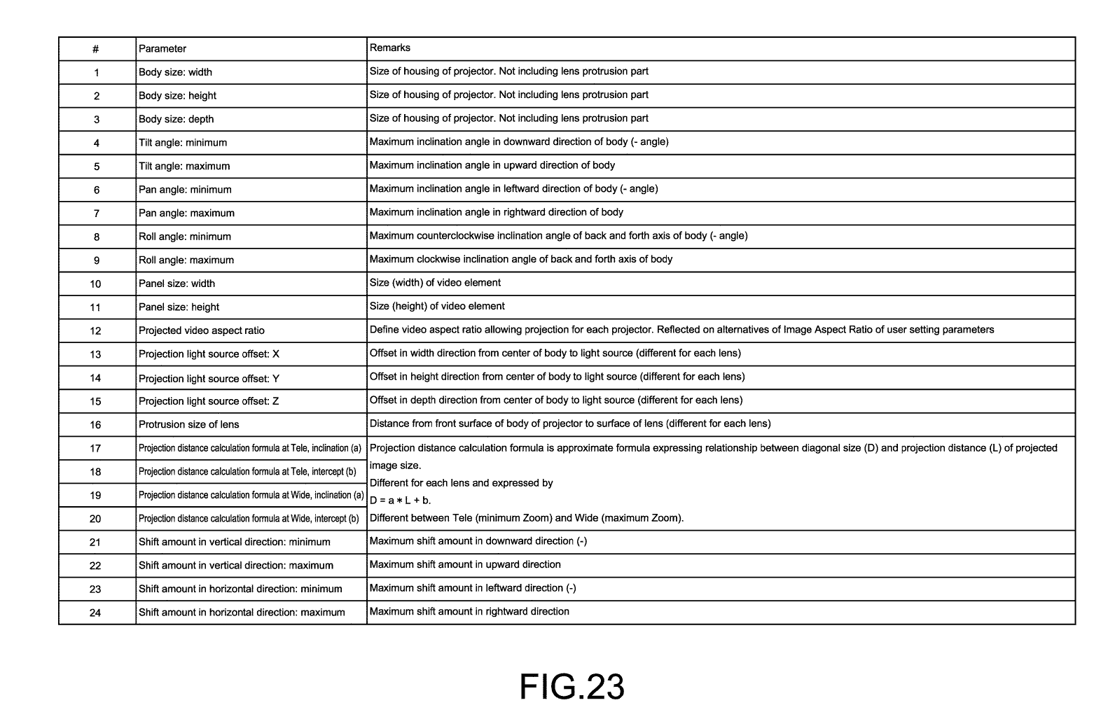

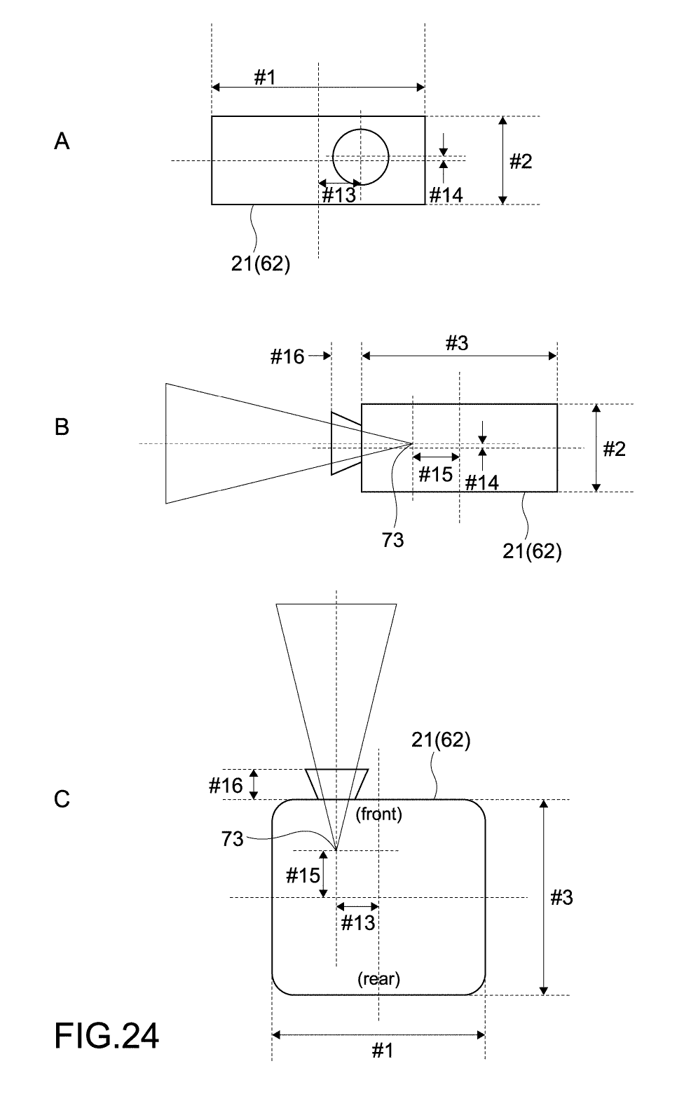

FIG. 23 is a table showing an example of the projector parameters stored in the storage unit 108. FIGS. 24 to 26 are schematic views for describing the projector parameters. FIGS. 24A, 24B, and 24C are a front part, a side view, and a plan view of a projector 21, respectively. The projector parameters are internal parameters stored for each type and each lens model of the projector 21.

As shown in FIGS. 23 and 24, the width, the height, and the depth of a housing 62 of the projector 21 are stored. It is possible to calculate the center of gravity of the housing 62 using these parameters. Note that the center of the gravity of the housing 62 is described as the center of a body in the table of FIG. 23.

In the present embodiment, the offset between the center of the gravity of the housing 62 and a position 73 of a virtual light source is stored. The position 73 of the virtual light source is a point at which a light beam for displaying an image is to be emitted, i.e., the position of the apex of a quadrangular pyramid of which the bottom surface serves as a display region 24. The position 73 of the virtual light source depends on a lens model but is typically set near a position at which a light source is actually arranged in the housing 62. Meanwhile, when an ultra short focus projector or a projector 21 that performs folding projection or the like with a mirror is simulated, a position 73 of a virtual light source can be set outside the housing 62.

Since the position 73 of the virtual light source is calculated on the basis of the stored offset, a simulation can be performed with high accuracy even when light is projected in any direction from the housing 62. For example, like the above case in which an ultra short focus projector or a projector that performs folding projection or the like is used, it becomes possible to simulate the projection of an image by an actual projector 21 with high accuracy.

As the projector parameters, the maximum angles of the respective inclinations of a tilt, a pan, and a roll are stored. When the respective angles of the tilt, the pan, and the roll are input via the attitude input unit 57 shown in FIG. 10, it becomes possible to input the angles within the ranges of the maximum angles. In addition, panel sizes provided in the housing 62 are stored as the projector parameters.

The aspect ratio of a projected image (video) is defined for each projector 21. The defined parameters are reflected on alternatives in the aspect ratio input unit 60 shown in FIG. 10. In addition, the protrusion size of a lens is also stored.

As parameters different for each lens model, an inclination (a) and an intercept (b) at each of Tele (minimum Zoom) and Wide (maximum Zoom) are stored. The inclination (a) and the intercept (b) are parameters corresponding to, for example, a field angle, a focal distance, or the like for each lens model.

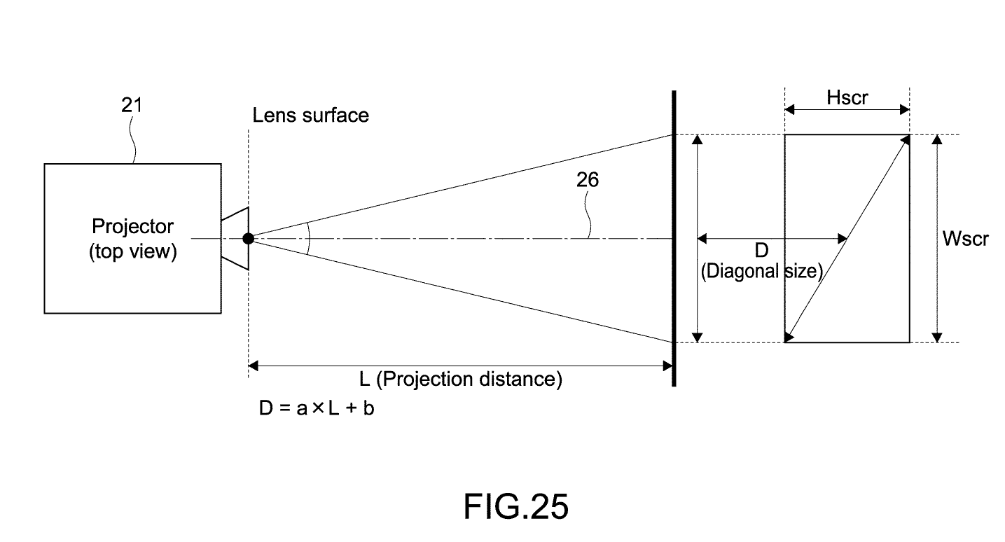

As shown in FIG. 25, the relationship between an image size D and a projection distance L at the Tele and the Wide can be established by the application of the inclination (a) and the intercept (b) to the projection distance calculation formula D=a×L+b. In addition, it is also possible to calculate a relational expression at other zoom magnifications from a relational expression at the Tele and the Wide.

Here, an example of a method for calculating a display region 24 of an image will be described. A virtual plane perpendicular to a light axis 26 of a projector 21 of which the position, the attitude, or the like has been set is arranged at a prescribed distance from a lens surface. By the projection distance calculation formula shown in FIG. 25, an image size D on the virtual plane is calculated. Vectors directed from the lens surface to arbitrary points in a virtual display region having the image size D on the virtual plane are calculated. A set of the collision points between extension lines in the directions of the vectors and the screen 23 corresponds to the display region 24 of the projected image.

Four vectors directed from the lens surface to four apexes in the virtual display region are calculated, the collision points between extension lines in the directions of the respective vectors and the screen 23 are calculated as the four apexes of the display region 24 of the image. A region obtained by connecting the four apexes to each other may be calculated as the display region 24. Alternatively, vectors may be calculated with respect to any point on the respective vertical and horizontal sides of a virtual display region to calculate the respective vertical and horizontal sides of the display region 24.

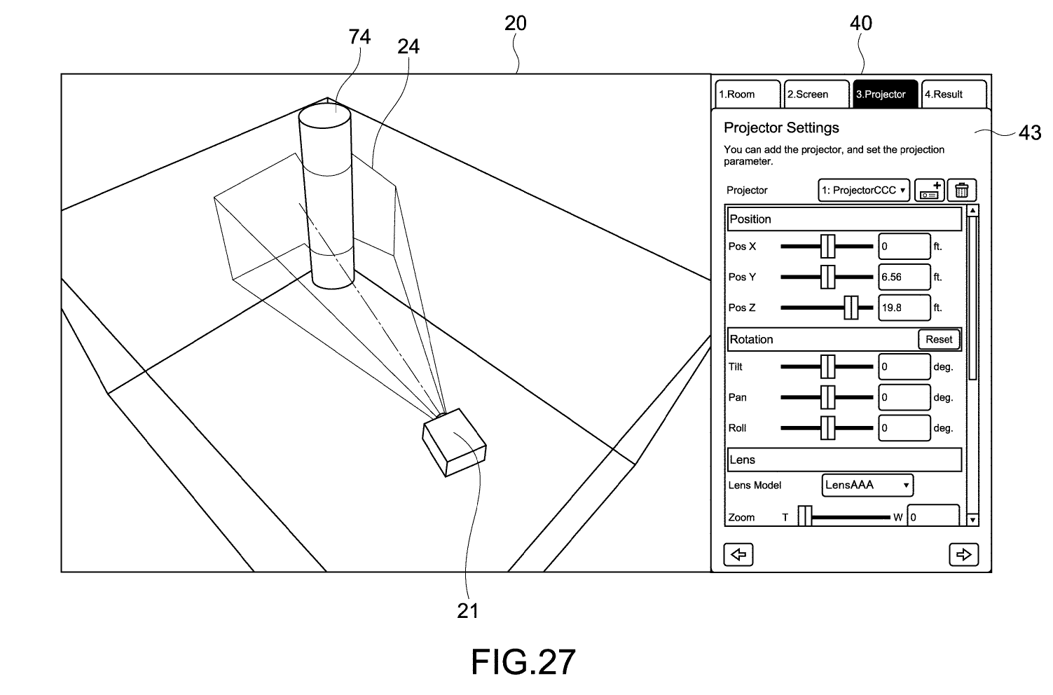

As described above, the virtual display region is set on the virtual plane, and the display region 24 of the projected image is calculated by the vectors calculated on the basis of the virtual display region. Accordingly, the display region 24 on the screen 23 having the curved surface shape as shown in FIG. 7 can be reproduced with high accuracy. In addition, as shown in FIG. 27, a display region 24 of an image projected onto a three-dimensional projected object 74 can also be reproduced with high accuracy. As a result, a simulation such as projection mapping or the like with which an image is to be projected onto a building, an object, or space can be performed with high accuracy. As shown in FIG. 27, an object different from a screen may be set as a projected object.

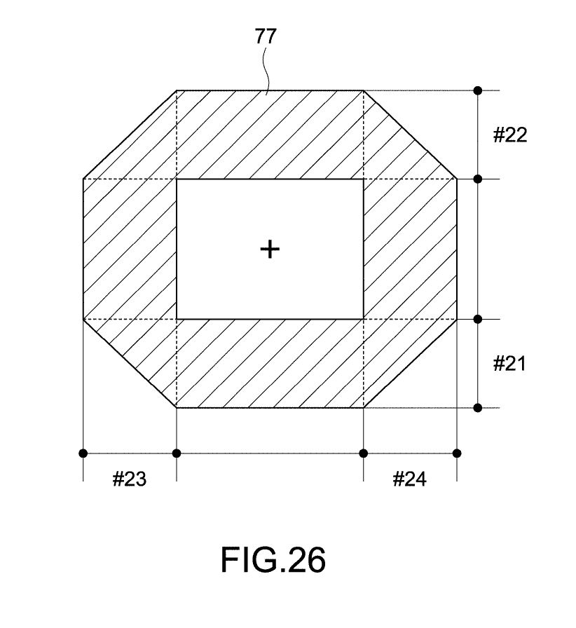

As shown in FIGS. 23 and 26, maximum values (minimum values) of lens shift amounts are stored as the projector parameters. A region 77 shown in FIG. 26 corresponds to a shift allowing region. When lens shift amounts are input via the lens shift amount input unit 61 shown in FIG. 10, it becomes possible to input the lens shift amounts within the range of the shift allowing region 77.

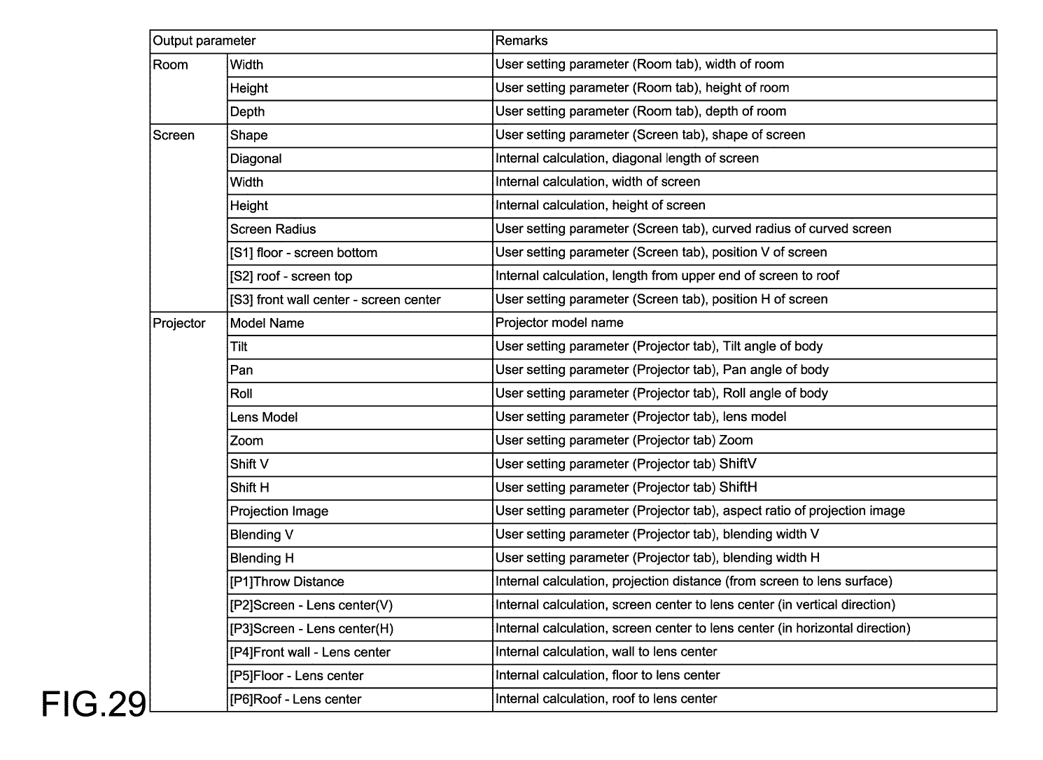

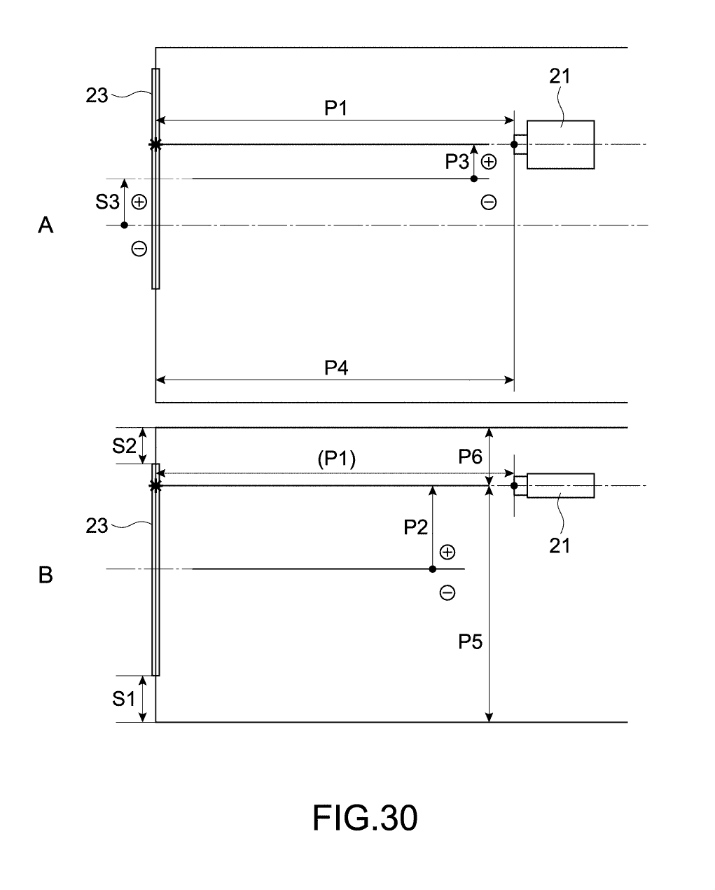

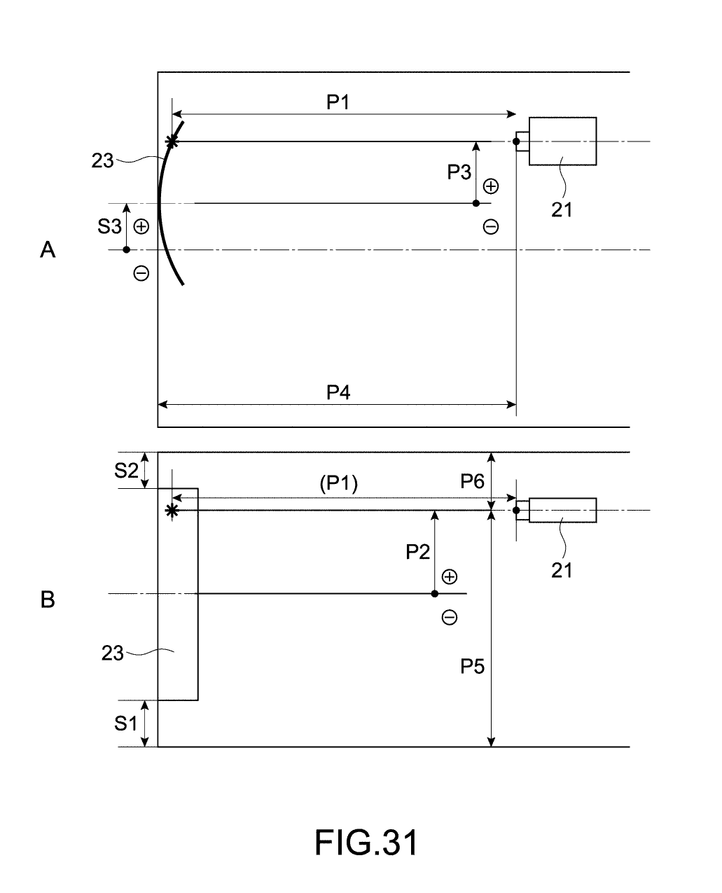

FIG. 28 is a view showing a configuration example of the list image 75 of a simulation result. FIG. 29 is a table showing an example of output parameters displayed in the list image 75. FIGS. 30 and 31 are views each showing a configuration example of a description image displayed for describing the output parameters. FIG. 30 is a description image when a screen 23 having a flat surface shape is selected (in which FIG. 30A is a plan view, and FIG. 30B is a side view). FIG. 31 is a description image when a screen 23 having a curved surface shape is selected (in which FIG. 31A is a plan view, and FIG. 31B is a side view).

As shown in FIGS. 28 and 29, the list image 75 displays user setting parameters set by a user 1 and internal calculation parameters internally calculated. In the present embodiment, the width, the height, and the depth of a room 22 input as first setting parameters are output as for the room 22.

In addition, the shape (curvature radius) and the positions (positions V and H) of a screen 23 input as second setting parameters are output as for the screen 23. In addition, the diagonal size, the width, the height, and the position (length from the upper end to the stack) of the screen 23 are output as internal calculation parameters.

As for a projector 21, the respective angles of a tilt, a pan, and a roll, a lens model, a zoom magnification, lens shift amounts, the aspect ratio of an image, and blending widths input as third setting parameters are output. In addition, a projection distance [P1], distances [P2] and [P3] from a screen center to a lens center, a distance [P4] from a wall to the lens center, a distance [P5] from a floor to the lens center, and a distance [P6] from a roof to the lens center are output as internal calculation parameters.

The user 1 can print the list of output parameters by selecting a print button 76 in the list image 75. In addition, the user can display the description images shown in FIGS. 30 and 31 on the display unit 106 by performing a prescribed operation.

The user 1 appropriately inputs user setting parameters to perform a desired simulation. Then, the user 1 causes output parameters and description images to be displayed on the display unit 106 or printed on a paper medium. It becomes possible to perform the installation of an actual projector or the setting of various parameters with high accuracy while confirming the output parameters and the description images.

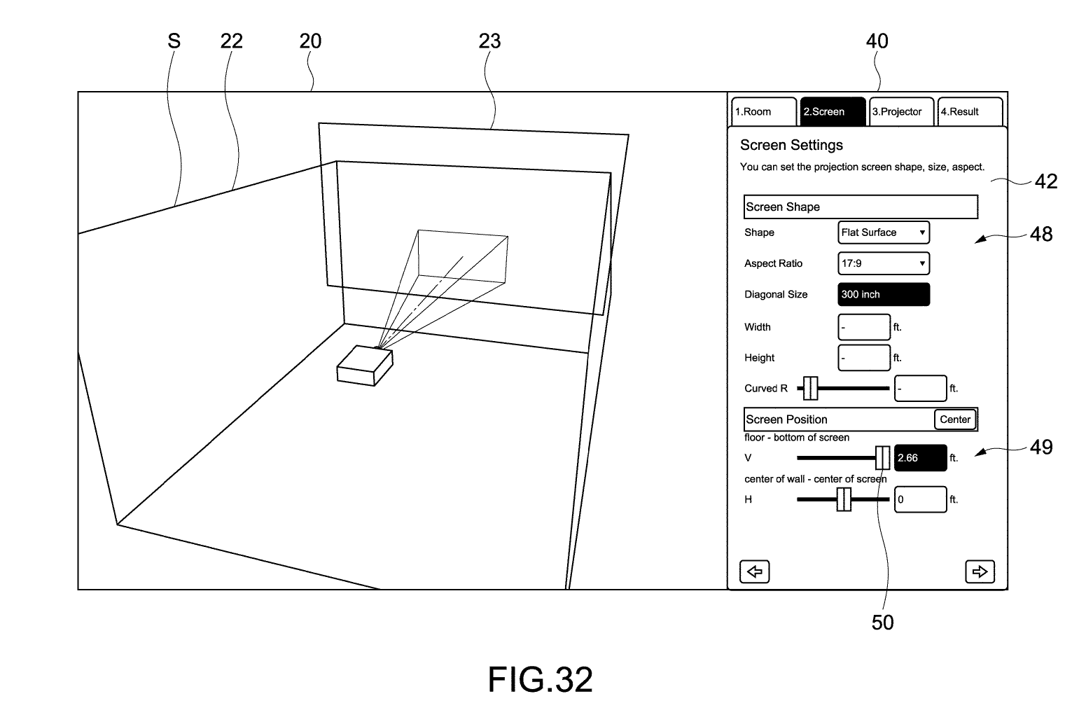

FIG. 32 is a view for describing an error display. In a second setting image 42 shown in FIG. 32, invalid values (mismatching values) are input to the size of the shape input unit 48 and a vertical position in the position input unit 49. That is, the values at which a screen 23 is protruded from a room 22 (space S) are input. In this case, the input setting information is highlighted. For example, the values of setting information and input windows in which the setting information is input are highlighted in a conspicuous color such as red. Thus, the user 1 is allowed to easily understand the input of invalid values.

When the screen 23 falls within the room 22 by the reduction of a size or the movement of a slider 50 or the like, an error display is cancelled with the recognition that the values have fallen within matching values. For example, when an error message or the like is displayed corresponding to the input of an invalid value, error confirmation processing or the like is required, which results in a cumbersome operation. In the present embodiment, an error is promptly discriminable by highlighting, and an error display is automatically cancelled when the values fall within matching values. Thus, it becomes possible to perform correction with no stress. Note that setting parameters for which an error display is to be performed, the definitions of invalid values, or the like are not limited but may be appropriately set.

As described above, an information processing apparatus according to the present embodiment is allowed to simulate various photographing conditions with high accuracy on the basis of setting information including user setting parameters and projector parameters. In particular, a simulation image 20 including a plurality of projectors 21 and the respective display regions 24 of a plurality of projected images is generated. Accordingly, it becomes possible to perform, for example, the simulation of large-screen display, high-brightness display, or the like with a plurality of projectors 21. As a result, it becomes possible to substantially assist the use of the projectors 21.

### Second Embodiment

An information processing apparatus of a second embodiment according to the present technology will be described. Hereinafter, the descriptions of the same configurations and functions as those of the information processing apparatus 100 in the above embodiment will be omitted or simplified.

FIG. 33 is a schematic view for describing an example of a simulation image according to the present embodiment. In the present embodiment, a simulation image 20 including a projected image 78 projected by a projector 21 is generated. That is, in the present embodiment, the simulation image 20 in which the projected image 78 is displayed inside the display region 24 is generated.

Typically, the projected image 78 is generated on the basis of the image information of an image selected by a user. For example, an image desired to be projected by the user actually using the projector 21 is selected from a file selection menu or the like. The image information of the selected image is acquired by the parameter acquisition unit 115, and the projected image 78 is generated by the image generation unit 116.

Of course, the projected image 78 is not limited to an image that is to be actually projected, but another image may be displayed as the projected image 78. For example, another video content may be selected, or a confirmation image or the like for confirming an image display state may be selected. For example, as a confirmation image for confirming how an image is to be displayed with a simulated arrangement or the like, an image such as a checker pattern may be prepared and selected.

In addition, besides a case in which the projected image 78 is selected by the user, an image prepared by default or an image specified by another cooperative application or the like may be automatically displayed as the projected image 78. Note that the format or the like of a source image 79 serving as the source of the projected image 78 is not limited, but video, a still image, or the like under any format is adoptable.

A method for generating the projected image 78 from the source image 79 serving as the source of the projected image 78 will be described with reference to FIG. 33. At a position distant from a light source 73 of the projector 21 by L′, a virtual plane perpendicular to a light axis 26 is set. As the light source 73 of the projector 21, a virtual point light source as shown in FIG. 25 is, for example, used. Note that the virtual plane may be set on the basis of the surface or the like of the lens of the projector 21.

A virtual projection region 80 in a case in which an image is to be projected onto the set virtual plane is set, and the source image 79 is arranged inside the virtual projection region 80. The virtual projection region 80 and the source image 79 are not displayed in the simulation image 20.

Coordinates V′ of the respective pixels of the source image 79 arranged inside the virtual projection region 80 are acquired, and the pixel data of the pixels and the coordinates V′ are associated with each other. The pixel data includes, for example, the information of the respective tones of red, green, and blue expressing the colors of the pixels, or the like.

Vectors V′ directed from the light source 73 to the coordinates V′ are extended to calculate coordinates V of collision points with a screen 23. The coordinates V are positions on the screen 23 of projected light emitted from the light source 73 and passing through the coordinates V′ and correspond to the projected positions of the respective pixels of the source image 79 projected onto the screen 23.

At the positions of the coordinates V on the screen 23, colors are expressed on the basis of the pixel data associated with the coordinates V′. That is, the respective pixels of the projected image 78 are generated. Thus, the simulation image 20 in which the projected image 78 is displayed inside the display region 24 is generated.

A method for displaying the projected image 78 is not limited. For example, representative pixels are selected from among the pixels included in the source image 79 arranged in the virtual projection region 80, and coordinates V that are projected positions on the screen 23 are calculated for the representative pixels. Using the coordinates V of the representative pixels, coordinates V of other pixels may be generated. Then, colors may be expressed on the basis of pixel data at the respective coordinates V to generate the projected image 78.

In addition, an image of which the resolution is reduced with respect to the source image 79 may be displayed as the projected image 78. For example, the source image 79 is divided into a plurality of divided regions each including a prescribed number of pixels. Representative pixels are selected from among pixels included in the divided regions. At projected positions (coordinates V) on the screen of all the pixels in the divided regions, a color is expressed by the pixel data of the representative pixels. That is, all the pixels in the divided regions are expressed by the same color on the screen 23. Thus, an image of which the resolution is reduced is displayed as the projected image 78, whereby a reduction in processing time or the mitigation of a burden on processing can be attained.

In the present embodiment, it is also possible to change the transmittance of the projected image 78 when displaying the projected image 78. The transmittance of the projected image 78 is determined by the image generation unit 116 according to, for example, simulation conditions or the like.

As the transmittance of the projected image 78 increases, the transparency of the projected image 78 displayed on the screen 23 is increased and the projected image 78 is thinned. Thus, the screen 23 or the like positioned on the back side becomes transparent, and the projected image 78 becomes unseeable (only the display region 24 is seeable) when the transparency is 100%. As the transmittance decreases, the transparency of the projected image 78 is decreased and the projected image 78 is thickened. Thus, the screen 23 or the like becomes unseeable, and the background is unseeable when the transparency is 0%.

By changing the transmittance, it becomes possible to simulate the brightness of an image actually displayed on the screen or the like. For example, an image projected darkly on the screen is expressed by the thinned projected image 78 of which the transmittance is set to be high. An image projected brightly is expressed by the thickened projected image 78 of which the transmittance is set to be low. Thus, a high-accuracy simulation is realized.

The transmittance is determined on the basis of various parameters on the brightness of the projected image 78. For example, it is possible to determine the transmittance on the basis of a distance L to the screen 23 onto which the projected image 78 is to be projected, the characteristics of a lens used in the projector 21, the reflectance of the screen 23, or the like.

In general, an image displayed on a screen becomes darker as the distance between a projector (light source) and the screen is longer. Accordingly, the transmittance is set to be higher as the distance L to the screen 23 is larger. For example, as the distance L to the screen 23, the distance L between a pixel positioned on the light axis 26 of the projector 21 and the light source 73 is calculated. In this case, the length of the vector V of the pixel on the light axis 26 is the distance L. The distance L may be calculated by other algorithms or the like.

The transmittance of the projected image 78 is determined on the basis of the calculated distance L and uniformly applied to the respective pixels of the projected image 78. Note that a method for calculating the transmittance from the distance L is not limited. For example, when the range or the like of a reference distance is set in advance and the distance L falls within the reference range, standard transmittance (for example, transmittance expressing standard brightness) is selected. On the basis of the standard transmittance, the transmittance corresponding to the distance L is determined. For example, a setting in which transmittance increases in proportion to a distance, a setting in which the inverse number of the square of a distance is subtracted from transmittance, or the like is assumed.

There is a case that the brightness of a projected image is different depending on the characteristics of a used lens. In addition, there is a case that unevenness occurs in the brightness of a projected image depending on the characteristics of a lens. For example, there could be a case that when an image is projected, the vicinity of the center of the image is displayed brighter than the end of the image.

By reflecting such characteristics of a lens, transmittance is appropriately determined for each lens model. For example, a lens with which an image is allowed to be brightly projected is set to have reduced transmittance. In addition, when a lens that causes a large amount of unevenness is, for example, used, the transmittance of the lens is set to be totally high (for example, the above standard transmittance is set to be high). Of course, the transmittance of a lens is not limited to such settings.

When the reflective screen 23 is used as shown in FIG. 33, the brightness of a displayed image is different depending on the reflectance of the screen 23. For example, when the reflectance of the screen 23 is high, a brighter image is displayed with an increase in a light amount of reflected light.

Accordingly, the transmittance of the reflected image 78 is determined on the basis of the reflectance of the screen 23. When the screen 23 having high reflectance is used, the transmittance is set to be small. When the screen 23 having low reflectance is used, the transmittance is set to be large.

As described above, it is possible to determine/change the transmittance of the projected image 78 on the basis of at least one of the distance L to the screen 23 onto which the projected image 78 is to be projected, the characteristics of a lens used in the projector 21, or the reflectance of the screen 23.

Note that brightness information expressing the brightness of the projected image 78 may be generated on the basis of these parameters or the like, and that the transmittance may be determined on the basis of the brightness information. Thus, it becomes possible to attain the simplification of processing for calculating the transmittance of the projected image 78 from a plurality of parameters. In addition, it becomes also possible to apply generated brightness information to other simulations.

As the brightness information, brightness (candela), illumination (lux), or the like calculated on the basis of respective parameters on brightness may be, for example, appropriately used. For example, brightness, illumination, or the like may be calculated based on respective parameters or the like on the basis of all light fluxes (lumen) expressing the brightness of the projector 21. Further, transmittance may be determined based on the calculated brightness, illumination, or the like. Thus, it becomes possible to simulate brightness with high accuracy.

It is also possible to determine transmittance for each of a plurality of pixels included in the projected image 78. That is, it is also possible to change transmittance for each of the pixels of the projected image 78. Thus, it is possible to perform a high-accuracy simulation.

For example, the transmittance of respective pixels is determined on the basis of distances A from the projector 21 (light source 73) to the respective pixels. For example, it is possible to use the lengths of the vectors V of the respective pixels as the distances A. Pixels of which the distance A to the projector 21 is longer are set to have higher transmittance. Accordingly, pixels in the vicinity of the center where the light axis 26 crosses are set to have lower transmittance, while pixels at the ends are set to have higher transmittance. Thus, it becomes possible to accurately simulate the distribution of the brightness of the projected image 78.

When brightness unevenness occurs in a projected image as the characteristics of a used lens, the transmittance of respective pixels is set according to the characteristics. For example, when the vicinity of the center of a projected image is more brightly displayed, transmittance reflecting the characteristics of the lens is set for each of pixels. On the basis of, for example, positions in the projected image 78 or distances from the light axis 26, pixels in the vicinity of the center are set to have lower transmittance while pixels at the ends are set to have higher transmittance. Thus, it becomes possible to simulate brightness unevenness as the characteristics of a lens with high accuracy.

On the basis of the reflectance of the screen 23 at the projected positions (coordinates V) of respective pixels, the transmittance of the respective pixels is set. For example, like a case in which the projected image 78 is displayed across a plurality of screens 23 having different reflectance, a case in which projection mapping is performed, or the like, there could be a case that a screen 23 onto which an image is to be projected is different for each region of an image.

That is, there could be a case that the right half of an image is projected onto a screen 23 having high reflectance, while the left half thereof is projected onto a screen 23 having low reflectance. Transmittance is determined on the basis of the reflectance of the screens 23 for each pixel, whereby it becomes possible to perform a simulation with high accuracy in this case.

Note that brightness information expressing brightness may be generated for each of the pixels of the projected image 78 on the basis of various parameters on the brightness. Then, the transmittance of the respective pixels may be determined from the generated brightness information of the respective pixels. For example, it is possible to generate the brightness information of respective pixels using the data, the physical model, or the like of the distribution of actually measured brightness. Thus, it becomes possible to display the brightness of the respective pixels of the projected image 78 with high accuracy.

In addition, in the present embodiment, it is also possible to specifically calculate the brightness of the projected image 78 and present the calculated brightness to a user. The brightness of the projected image 78 is displayed at a prescribed display position provided in the simulation image 20 with a numerical value according to, for example, a prescribed operation by the user using a mouse or the like. Thus, it is possible to understand, on the basis of a specific numerical value, how the whole brightness of the projected image 78 changes depending on simulation conditions. As the brightness of a projected image, a relative value based on standard brightness or the value of illumination, brightness, or the like is, for example, displayed.

For example, when transmittance is directly determined on the basis of parameters such as the distance L to the screen 23 and the characteristics of a lens, brightness is calculated from the determined transmittance. For example, the relationship between brightness and transmittance is stored in advance, and brightness is read from determined transmittance. Alternatively, the brightness of the projected image 78 may be calculated on the basis of parameters such as the distance L and the characteristics of a lens.

When the brightness information of the projected image 78 is generated on the basis of parameters such as the distance L to calculate transmittance, the brightness information may be directly displayed as the brightness of the projected image 78. Thus, it becomes possible to attain the simplification of processing.

When transmittance is set for each pixel, brightness is calculated for each pixel and presented to the user. When brightness information is generated for each pixel to calculate transmittance, the brightness information may be directly displayed as the brightness of the respective pixels.

A position on the projected image 78 is selected using, for example, a mouse or the like. The brightness of the pixels of the position is displayed at a prescribed display position as a specific numerical value. The brightness of the selected position (pixels) may be displayed next to a mouse cursor or the like as a pop-up image. Thus, it becomes possible to understand the brightness of respective positions in the projected image 78 and easily compare the brightness of different positions with each other.

As described above, the simulation image 20 including the projected image 78 is generated by the image generation unit 116 according to the present embodiment. Thus, it becomes possible to confirm, for example, how the respective pixels of an image used in actual projection are to be projected onto the screen 23.

In the present embodiment, the drawing coordinates V on the screen 23 are calculated from the collision points between the light beam vectors V from the light source 73 and the screen 23. Therefore, even if a screen onto which an image is to be projected has any shape, the same algorithm is applicable. Thus, even in a case in which a complicated screen like projection mapping is, for example, assumed, it becomes possible to properly simulate the appearance of a projected image.

When the projected image 78 is displayed, the transmittance of the projected image 78 is determined on the basis of information of an actually used screen or a projector. Thus, it becomes possible, for example, to easily confirm to what extent a projected image displayed in actual projection is to be brightly displayed.

In addition, it is possible to change the transmittance of the respective pixels of the projected image 78. Accordingly, a difference in brightness or the like for each pixel corresponding to the shape or the like of a screen can be, for example, properly displayed. Thus, it becomes possible to reproduce the distribution of the brightness of an actually projected image or the like with high accuracy.

In addition, since the projected image 78 has transparency corresponding to transmittance, it becomes possible to easily display a plurality of projected images in a stacked state, for example. Accordingly, it becomes possible to visually confirm, for example, the blending, the stacking, or the like of a plurality of projected images.

In addition, it is possible to display the brightness of the projected image 78 with a specific numerical value. Thus, it becomes possible to easily understand the brightness value or the like of the projected image 78. Accordingly, it becomes possible to understand, for example, a change in the appearance of a projected image or the like when simulation conditions are changed as a specific change in a numerical value. As a result, it becomes possible to efficiently advance a simulation.

### Third Embodiment

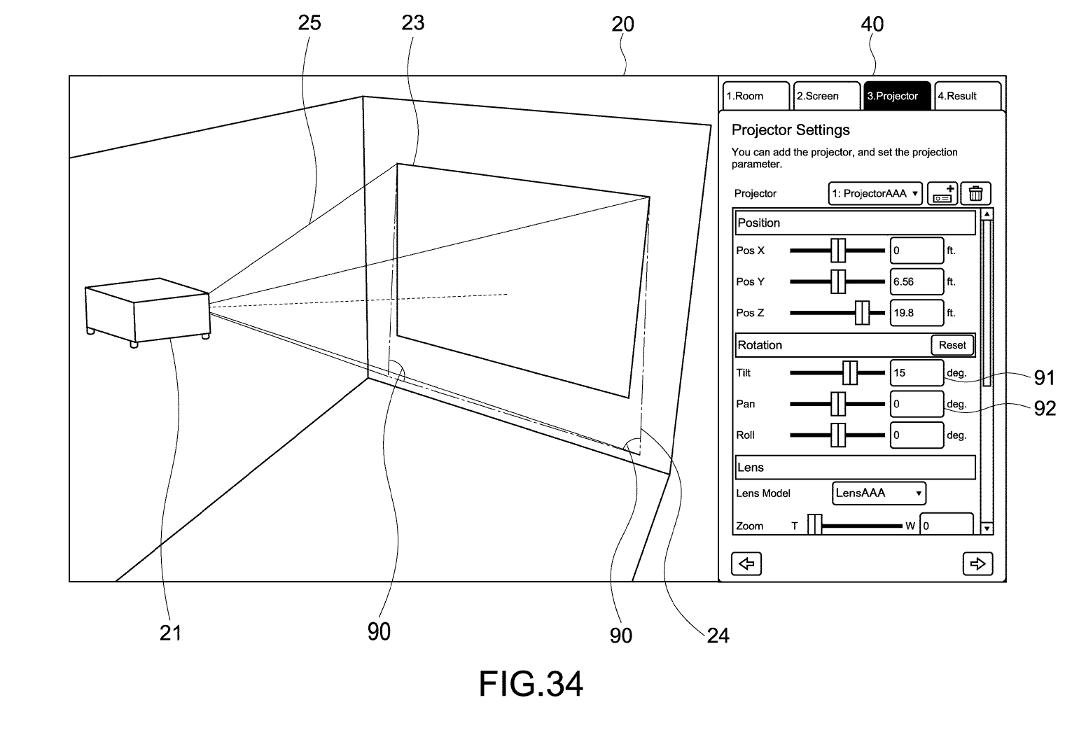

FIG. 34 is a view showing an example of a simulation image according to a third embodiment of the present technology. As shown in FIG. 34 or FIG. 20 used to describe the first embodiment, a simulation image 20 including distortion of an image projected by a projector 21 is generated in an information processing apparatus according to the present technology.

When a projector is actually arranged and an image is projected, there is a case that distortion occurs in the projected image according to the attitude of the projector 21, the arrangement of a screen 23, or the like. That is, there is a case that an image having a trapezoidal shape or the like is displayed due to the deformation of a projected image.

Like, for example, the simulation image 20 shown in FIG. 34, it is assumed that an image is projected toward the screen 23 by the projector 21 tilted downward. Due to the tilt of the projector 21, the lengths of the light paths of projected light beams 25 are made different. As a result, the lower side of a display region 24 becomes longer than the upper side of the display region 24, and the display region 24 distorted in a trapezoidal shape is generated. In addition, by the projector 21 tilted from side to side, for example, a display region 24 distorted in a trapezoidal shape of which the lengths of the left side and the right side are different is generated.

A display region 24 expressing distortion of an image is generated and displayed as described above, whereby it becomes possible to simulate image projection by an actual projector with high accuracy. In an example shown in FIG. 34, for example, the upper side of the display region 24 is aligned with the upper side of the screen 23. Since the screen 23 is included in the display region 24 having a trapezoidal shape, it is possible to understand that a user 1 can appropriately correct distortion of an image to properly display the image on the screen 23.

As a method for geometrically correcting (warping correction) the shape of an image, it is assumed that source image information is corrected using a computer such as a PC. In this case, it becomes possible to greatly correct distortion of an image and substantially correspond to the occurrence of the distortion of the image.

It is also assumed that warping correction is performed by an image distortion correction function provided in a projector. The warping correction is performed by, for example, an image processing IC (Integrated Circuit) or the like inside the projector 21. In this case, a range in which the warping correction is allowable is determined by the specifications of the image processing IC or the like. Therefore, an amount at which distortion of an image can be corrected is smaller compared with a case in which a PC or the like is used. Accordingly, there could be a case that distortion of an image is not completely corrected.

In the present embodiment, a determination is made as to whether distortion of an image is correctable. In particular, a determination is made as to whether an image is properly displayed when the distortion correction function of the projector 21 is in use. In an example shown in FIG. 34, a determination is made as to whether an image can be properly displayed inside the screen 23 by the distortion correction function of the projector 21.

A determination as to whether distortion of the display region 24 is correctable is performed by a determination unit. The determination unit is realized, for example, when the CPU 101 shown in FIG. 1 performs a prescribed program according to the present technology.

The determination unit determines whether distortion of the display region 24 is correctable on the basis of at least one of distortion of a projected image (distortion of the display region 24) or correction function information regarding the distortion correction function of the projector 21. The correction function information of the projector 21 is stored in the storage unit 108 as projector parameters and includes, for example, condition information regarding conditions under which distortion of the display region 24 is correctable.

Examples of condition information based on which distortion is correctable include a condition on the distortion of the simulated display region 24, i.e., a condition on the shape of the display region 24. That is, it is determined that correction is allowable when the information of a correctable shape is stored as condition information, and that the shape of the simulated display region 24 falls within the range of the correctable shape.

The range of the correctable shape is stipulated by, for example, the angle of both ends of the long side of a trapezoid. As for the angle, a prescribed angle less than 90 degrees is set as a threshold. For example, the angle 90 degrees of both ends of the long side (lower side) of the display region 24 shown in FIG. 34 is compared with a threshold angle. When the angle 90 degrees of both ends of the long side of the display region 24 is greater than the threshold, it is determined that correction is allowable. When the angle 90 degrees of both ends of the long side of the display region 24 is smaller than the threshold, it is determined that the correction is not allowable. Note that a method for stipulating the range of the correctable shape is not limited, but a determination may be made as to whether the correction is allowable on the basis of the angle of both ends of the short side of the trapezoid.

As the condition information based on which the distortion is correctable, a condition such as the installation angle or the like of the projector 21 may be, for example, stored. That is, the range of the angle of the tilt or the pan of the projector 21 based on which distortion of an image is correctable is stored. When the installation angle of the projector 21 falls within the range of the stored angle, it is determined that correction is allowable. When the condition is not met, it is determined that the correction is not allowable.

Note that determination processing may be performed on the basis of the relative angle (projection angle) or the like between the projector 21 and the screen 23. Thus, it is possible to properly perform the determination processing even when the screen 23 is tilted.

A method for determining whether correction is allowable is not limited to the above method. Any determination method using various parameters used in a simulation or new parameters for determination may be adopted.

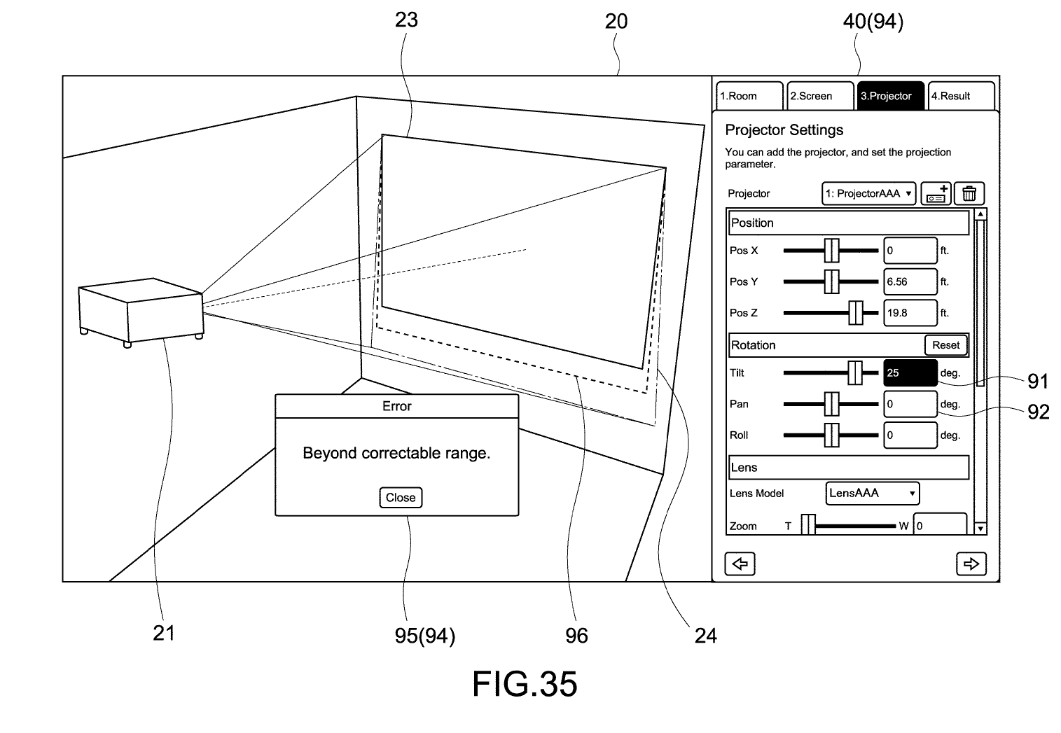

FIG. 35 is a view showing an example of a notification image for notifying a determination result by the determination unit. In the present embodiment, a notification image 94 for notifying the user 1 of a determination result by the determination unit is generated by the image generation unit 116. For example, user setting parameters such as the angles 92 and 93 of the tilt and the pan of a projector 21 are changed by a user. The determination unit performs determination processing according to a change in the user setting parameters and outputs a determination result. The image generation unit 116 generates the notification image 94 on the basis of the output determination result.

For example, the setting image 40 in which parameters input by a user are highlighted is generated as the notification image 94. For example, at a timing at which it is determined that correction is unallowable, the angles 91 and 92 of the tilt and the pan of the projector 21 input at that time are highlighted. When distortion of an image is correctable, the setting image 40 for a normal state is displayed. Thus, it becomes possible to easily notify the user of whether distortion correction is allowable. Of course, an image (such as an OK mark) indicating the fact that correction is allowable may be displayed as the notification image 94.

In addition, when it is determined that correction is unallowable, a pop-up image 95 in which a message indicating the fact is described may be generated and displayed in the simulation image 20. Thus, it becomes possible to reliably notify a determination result. In this case, the pop-up image 95 corresponds to the notification image 94. The type or the like of the notification image 94 is not limited, but any image notifying a determination result may be used. Note that a determination result may be notified using sound or the like.

In addition, in an example shown in FIG. 35, a correction region 96 indicating a range in which distortion of the display region 24 can be corrected is displayed. The correction region 96 is generated on the basis of, for example, the correction function information or the like of the projector 21.

As the correction region 96, a maximum range in which an image can be properly corrected is, for example, displayed. It is possible to generate the correction region 96 having a trapezoidal shape from, for example, the threshold of an angle of both ends of the long side of a trapezoid or the like indicating correction function information. Thus, when the display region 24 protrudes from the correction region 96, for example, it is possible to determine that an image cannot be properly corrected inside the screen 23 with the distortion correction function of the projector 21.

In addition, a correction result image obtained after the display region 24 is corrected using the distortion correction function may be, for example, displayed (not shown). The user can determine whether distortion of an image can be properly corrected by seeing the correction result image. In addition, it is also possible to determine that distortion of a corrected image falls within an allowable range even when the distortion of the image is not completely corrected.

As described above, the simulation image 20 including distortion of the display region 24 is generated by the image generation unit 116 in the present embodiment. Thus, it becomes possible to perform a high-accuracy simulation in which distortion of an image caused by projection is reproduced.

In general, when a projector is tilted, a projection shape is displayed in a state of being distorted in a trapezoidal keystone shape. The cancellation of the keystone shape using a distortion correction function provided in the projector cannot be confirmed until the projector is actually installed, and the reattempt of a simulation may be needed.

In the present embodiment, the determination unit determines whether distortion of a projected image is correctable on the basis of the correction function information or the like of the projector 21. Then, the notification image 94 notifies a user of a determination result. Thus, it becomes possible to properly perform a simulation according to the characteristics of a projector or the like. Accordingly, it becomes possible to improve accuracy in a simulation and substantially eliminate the possibility of the reattempt or the like of the simulation.

In addition, in the present embodiment, the correction region 96 is displayed as an image expressing a range in which distortion of an image is correctable. Thus, it becomes possible to easily perform a simulation according to, for example, a range in which keystone (trapezoid) correction or the like is allowable.

### Fourth Embodiment

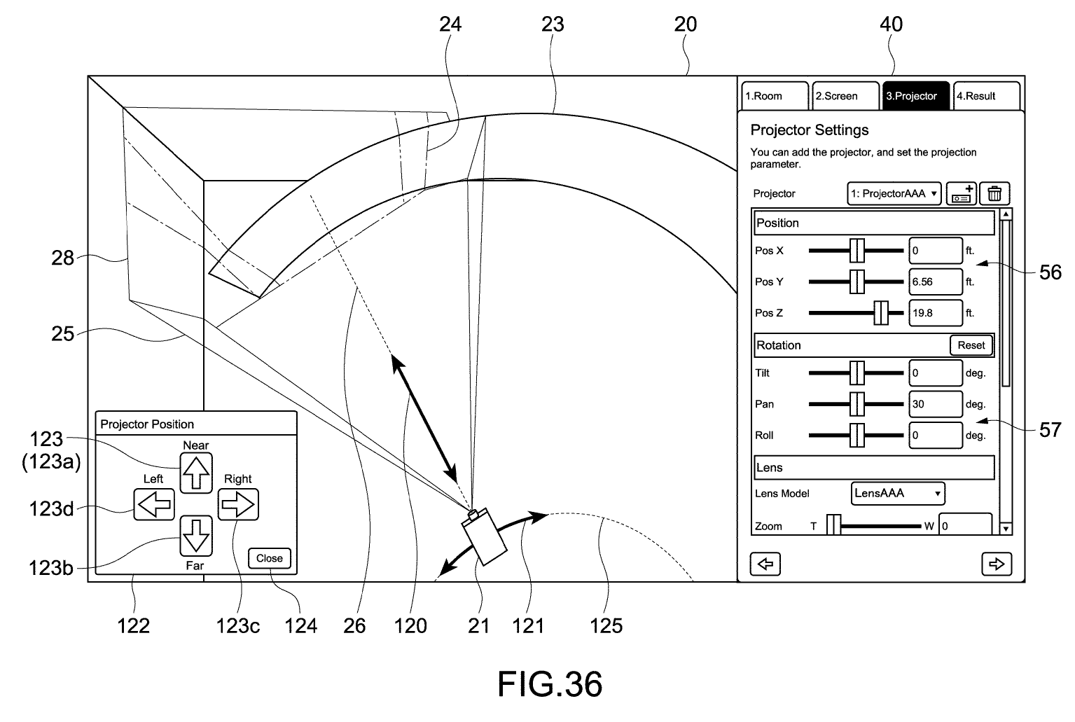

FIG. 36 is a schematic view for describing an example of a simulation image according to a fourth embodiment of the present technology. In the present embodiment, it is possible to input movement amounts along the direction of a light axis 26 and movement amounts of movement based on the shape of a screen 23. That is, in the present embodiment, it is possible to move a projector 21 along the direction of the light axis 26 in a simulation image 20. In addition, it is possible to move the projector 21 according to the shape of the screen 23.

The respective movement amounts of movement (arrow 120) along the direction of the light axis 26 and movement (arrow 121) based on the shape of the screen 23 are input via, for example, a movement setting image 122 shown in FIG. 36 as user setting parameters.

The movement setting image 122 has a movement direction button 123 for inputting the respective movement amounts of the projector 21. The movement setting image 122 is displayed in the simulation image 20 by, for example, double-clicking the light axis 26. In addition, it is possible to cancel the movement setting image 122 with a close button 124. A method for displaying the movement setting image 122 is not limited. For example, a button for displaying the movement setting image 122 may be provided in the setting image 40, and the movement setting image 122 may be displayed by pressing the button.

When the distance between the projector 21 and the screen 23 is changed along the direction of the light axis 26, the position (XYZ coordinate values) of the projector 21 is automatically changed. On the other hand, since the crossing position and the crossing angle of the light axis 26 with respect to the screen 23 are not changed, the attitude (the angles of the tilt, the pan, the roll) of the projector 21 is not changed. Note that XYZ coordinate values or the like after movement are appropriately displayed in the position input unit 56.

When a near button 123a included in the movement direction button 123 is selected, the projector 21 is moved along the direction of the light axis 26 to a side (front side) from which projected light is emitted. The projector 21 may be moved by a prescribed amount with a single click, or time during which the near button 123a is pressed and a movement distance may be associated with each other. That is, the movement of the projector 21 may be continued while the near button 123a is pressed.

When a far button 123b is selected, the projector 21 is moved to a side (rear side) opposite to the side from which projected light is emitted. Movement amounts are input via the near button 123a and the far button 123b as described above, and the projector 21 is moved in the direction of the light axis 26 according to the movement amounts. Thus, it becomes possible to easily change the distance between the screen 23 and the projector 21 while maintaining, for example, the attitude of the projector 21 with respect to the screen 23.

The movement based on the shape of the screen 23 is typically movement along the shape of the screen 23. Since a path along the shape of the screen 23 is set, it becomes possible to move the projector 21 along the path. When the screen 23 has, for example, the shape of a flat surface, a straight line parallel to the flat surface is set as a path. When the screen 23 has a curved surface, a path along the curved surface is appropriately set.

Note that as the movement based on the shape of the screen 23, the projector 21 may be moved along, for example, a principal surface onto which an image is to be principally projected. Thus, for example, even when the surface of the screen 23 has holes, protrusions, or the like, it is possible to properly move the projector 21. Besides, a path desired by a user may be appropriately set on the basis of the shape of the screen 23.

In FIG. 36, a curved shape is selected as the shape of the screen 23, and the curvature radius or the like of the screen 23 is set (see FIG. 7). For example, a circumference 125 of a circle based on the center of the curvature radius of the screen 23 is set as a path on which the projector 21 moves. The circumference 125 of the circle is set on the basis of, for example, a distance from the center of the curvature radius to the gravity of center of the projector 21. As a result, the projector 21 moves on a path concentric with the screen 23 and moves along the shape of the screen 23.

The movement amount of the projector 21 along the circumference 125 of the circle is input via a right button 123c and a left button 123d that are movement direction buttons 123. For example, when the right button 123c is selected, the projector 21 is moved along the circumference 125 of the circle rightward with respect to a direction in which an image is projected. In addition, when the left button 123d is selected, the projector 21 is moved leftward along the circumference 125 of the circle.

In the present embodiment, the angle of the light axis 26 of the projector 21 with respect to the screen 23 is maintained when the projector 21 is moved. The angle of the light axis 26 of the projector 21 with respect to the screen 23 is, for example, an angle formed between the normal line of the screen 23 and the light axis at a position at which the screen 23 and the light axis 26 cross each other.

For example, an angle between the light axis 26 and the screen 23 is calculated according to the movement of the projector 21 along the circumference 125 of the circle. Further, the angle or the like of the pan of the projector 21 is appropriately changed to maintain the angle. The position (XYZ coordinates) and the attitude (the angles of the tilt, the pan, and the roll) of the moved projector are displayed in the position input unit 56 and the attitude input unit 57.

Thus, it becomes possible to move the display region 24 from side to side without changing, for example, the shape or the like of the display region 24. Note that a method or the like for maintaining the angle between the screen 23 and the light axis 26 is not limited. For example, any algorithm or the like for rotating and moving the projector 21 may be used.

Note that the attitude of the projector 21 may not be changed to be moved. That is, the projector 21 may be moved along the circumference 125 of the circle while maintaining the same angles of the tilt, the pan, and the roll. Thus, it becomes possible to easily adjust the position of the projector 21 according to, for example, the shape of the screen 23.

As shown in FIG. 36, a light beam 25, a projected region 28, or the like projected over the rear surface or the wall surface of the screen 23 from the projector 21 is displayed in the simulation image 20, besides lines expressing the display region 24 on the screen 23. Accordingly, since the path or the like of reflected light can be known in detail, it is possible to perform a high-accuracy simulation.

As described above, in the present embodiment, movement amounts along the direction of the light axis 26 of the projector 21 are set as user setting parameters, and movement along the direction of the light axis 26 of the projector 21 is simulated. In addition, the movement amounts of movement based on the shape of the screen 23 are set as user setting parameters, and movement based on the shape of the screen 23 is simulated.

For example, when a projector is moved under the settings of XYZ orthogonal coordinates, there is a likelihood that a projected field angle or the like is changed on a screen that does not have a flat surface shape. Therefore, the attitude, the position, or the like of the projector is required to be adjusted to maintain the projected field angle or the like, which results in a complicated operation.

Since the projector 21 is moved along the direction of the light axis 26 in the present embodiment, the angle of the light axis 26 with respect to the screen 23 is maintained. Accordingly, it becomes possible to move the projector 21 away from or close to the screen 23 without having influence on a projected field angle with respect to the screen 23. Thus, it becomes possible to easily perform an intuitive layout consideration operation.

In addition, in the present embodiment, the projector 21 is moved along the shape of the screen 23 while maintaining the angle of the light axis 26 with respect to the screen 23. Accordingly, it becomes possible to move a projected position or the like on the screen 23 by the projector 21 without having influence on a projected field angle or the like with respect to the screen 23. Thus, it becomes possible to smoothly perform a simulation.

For example, it is also possible to move a projector duplicated using a duplicate function along the shape of a screen. Thus, it becomes possible to easily perform processing such as stacking and blending by a plurality of projectors shown in FIGS. 15 to 19 or the like on a curved screen as well.

### Fifth Embodiment

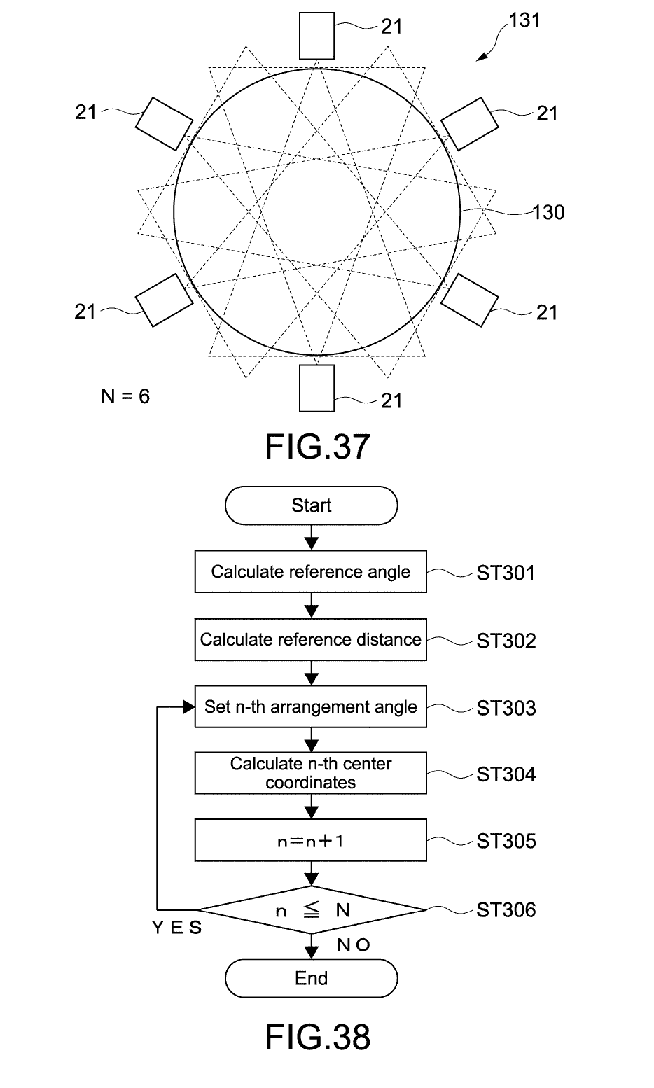

FIG. 37 is a schematic view for describing an example of a simulation image according to a fifth embodiment of the present technology. In the present embodiment, a simulation image is generated that includes a layout image 131 expressing the arrangement state of a plurality of projectors 21 based on a screen 130 onto which an image is to be projected. That is, in the present embodiment, a layout (arrangement state) in which a plurality of projectors 21 are arranged on the basis of the screen 130 is created, and the confirmation of the layout in the simulation image is made possible.

Specifically, the layout of a plurality of projectors 21 is determined by calculating each of arrangements such as the positions and the attitudes of the respective projectors. The recommended arrangements of the respective projectors 21 are calculated according to, for example, the screen 130 desired by a user.

In the present embodiment, the arrangements of the respective projectors 21 are calculated on the basis of the information of the screen 130 such as the shape, the size, and the position of the screen 130 and the number N of the used projectors 21. Then, the layout image 131 expressing the calculated arrangements of the respective projectors is generated and displayed in the simulation image. Accordingly, it is possible to confirm a layout in the desired screen 130 with, for example, the specification of the number N of the projectors 21.

The information of the screen 130 is input via, for example, the second setting image 42 or the like shown in FIG. 6, 7, or the like. For example, the radius of a sphere or the coordinates of the center of the sphere are input when the screen has, for example, a dome shape, or the width, the curvature radius, the center coordinates of a curve, or the like is input when the screen has, for example, a curved shape.

The number of the used projectors 21 is input via, for example, a layout setting image (not shown) or the like for generating a layout. Note that the information of the type or the like of the projectors 21 is input via, for example, the third setting image 43 or the like shown in FIG. 10 or the like.

In addition, it is possible to select a projection mode as to which direction projection is to be performed on the screen 130 via a layout setting image or the like. For example, when the screen 130 is dome-shaped, a mode in which projection is to be performed from the outside to the center of the screen 130, a mode in which projection is to be performed from the center to the outside of the screen 130, or the like is selected.

In an example shown in FIG. 37, a dome-shaped screen 130 is selected, and the number N of projectors is set at six. The six projectors are evenly arranged around the dome-shaped screen 130 and set to have an attitude so that each of the projectors is capable of projecting an image from the outside to the center of the screen 130.

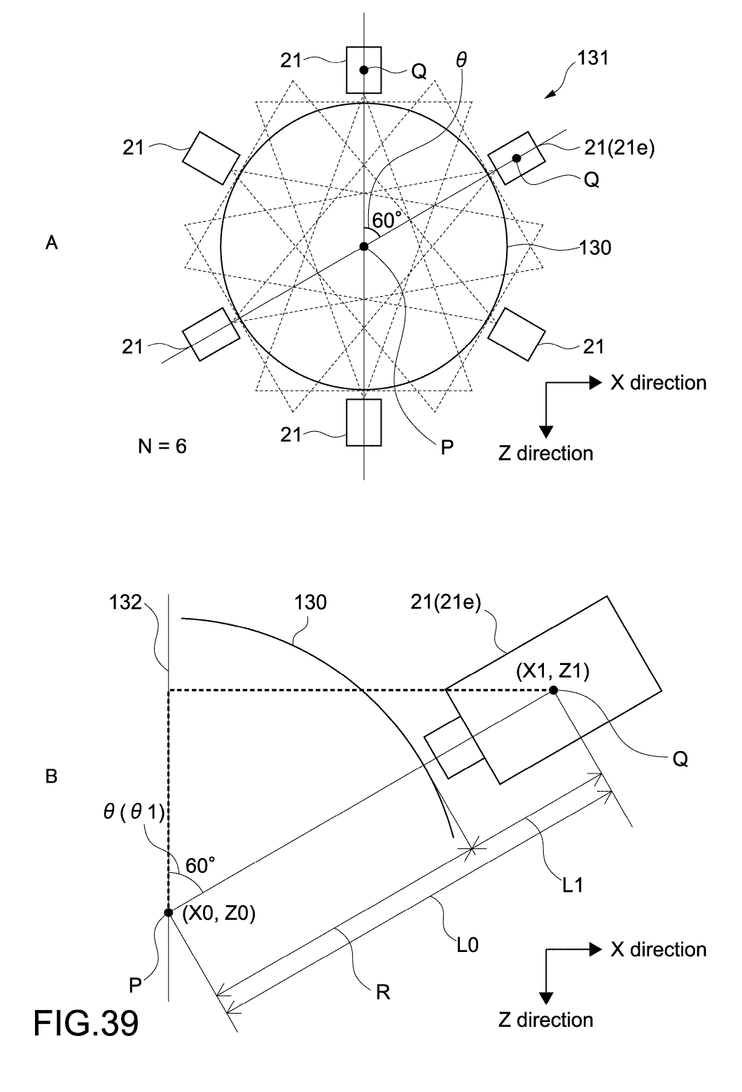

FIG. 38 is a flowchart showing an example of calculating the layout of a plurality of projectors. FIG. 39 is a schematic view for describing the flowchart and illustrates a case in which the layout shown in FIG. 37 is calculated. Note that FIG. 39B is an enlarged view for describing a method for calculating the coordinates of the projectors 21.

First, a reference angle θ serving as a reference for calculating the attitude or the like of the projectors 21 is calculated (step 301). In FIG. 39A, an angle formed by two straight lines directed from a center P of the screen 130 to respective centers Q of two adjacent projectors is calculated as the reference angle θ. For example, an angle (360°) corresponding to the full circle of the periphery of the screen 130 is divided by the number N of the projectors (six) to calculate the reference angle θ (60°).

A reference distance L0 serving as a reference for calculating the positions of the projectors 21 is calculated (step 302). In FIG. 39B, a distance from the center P of the screen 130 to the centers Q of the projectors 21 is calculated as the reference distance L0. For example, the sum of a radius R of the screen 130 and a distance L1 from the centers Q to the tip ends of the lenses of the projectors 21 is calculated as the reference distance L0. That is, L0=R+L1 is established. Thus, the reference distance L0 is calculated in a layout in which the tip ends of the lenses contact the surface of a sphere (the dome-shaped screen 130).

A method or the like for calculating the reference distance L0 is not limited. For example, the reference distance L0 may be calculated in a layout in which the tip ends of the lenses are separated from the surface of the sphere by a prescribed distance. In this case, the sum of the radius R of the screen 130, the distance L1 from the centers Q to the tip ends of the lenses of the projectors 21, and the prescribed distance corresponds to the reference distance.

Note that the distance L1 from the centers Q to the tip ends of the lenses of the projectors 21 is appropriately calculated from the projector parameters (see FIG. 23) or the like of the used projectors 21. In addition, when the type or the like of the projectors 21 is not selected, a value set by default is appropriately used.

The arrangement angle of the n-th projector 21 is set (step 303). The arrangement angle is an angle at which coordinates, directions, or the like for arranging the projectors 21 are set. In an example shown in FIG. 39B, an arrangement angle θn (n=1 to N) is set on the basis of a straight line 132 parallel to a Z-axis and crossing the center P of the screen 130.

For example, a reference angle θ (60°) is set as an arrangement angle θ1 of the first projector 21e (n=1). As shown in FIG. 39B, an angle formed by rotating the straight line 132 parallel to the Z-axis clockwise by the reference angle θ (60°) based on the center P of the screen 130 is set as the arrangement angle θ1 of the first projector. At this time, the angle of the pan of the first projector 21e is calculated on the basis of the arrangement angle θ1 so that projection toward the center of the screen 130 is allowed.

The center coordinates of the n-th projector 21 are calculated (step 304). The coordinates (Xn, Zn) of the centers Q of the projectors 21 are calculated on the basis of the arrangement angles θn and the reference distances L0 of the projectors 21 and the coordinates (X0, Z0) of the center of the screen 130.

As shown in, for example, FIG. 39B, it is possible to calculate the coordinates of the center Q of a projector 21 from a right triangle having a line segment PQ of a length L0 as an oblique line on the basis of the center P of the screen 130. For example, the center coordinates (X1, Z1) of the first projector 21e are calculated as follows.

X1=X0+L0×sin(θ1)=X0+(R+L1)×sin(60°)

Z1=Z0+L0×cos(θ1)=Z0+(R+L1)×cos(60°)

The numerical order (n) of the projector 21 is updated to the numerical order (n+1) of a next projector 21 (step 305), and a determination is made as to whether the updated numerical order of the projector 21 is the number N of the projectors 21 or less (step 306).

When the numerical order of the projector 21 is the number N of the projectors 21 or less (YES in step 306), the arrangement angle θn of the next projector 21 is set to continue the steps. As the arrangement angle θn of the n-th projector, an angle n times as large as the reference angle θ is, for example, set. That is, the second projector is set to have an arrangement angle θ2 of 60°×2=120°. As described above, the reference angle θ (60°) is each added to the arrangement angle θn to perform the above processing, whereby it is possible to calculate the center coordinates or the like of the corresponding number of the projectors 21.

When the numerical order of the projector 21 is greater than the number N of the used projector 21 (NO in step 306), the arrangements of all the projectors 21 are calculated to end the processing. Thus, each of the center coordinates (positions) and the angles (attitudes) of the pans of the N projectors 21 is calculated.

By the image generation unit 116, the layout image 131 of the N projectors is generated on the basis of the calculated positions and the attitudes of the projectors and displayed in a simulation image. As described above, it is possible to generate a simulation image including the layout image 131 of the plurality of projectors 21 on the basis of the information of the screen 130 and the number N of the used projectors 21.

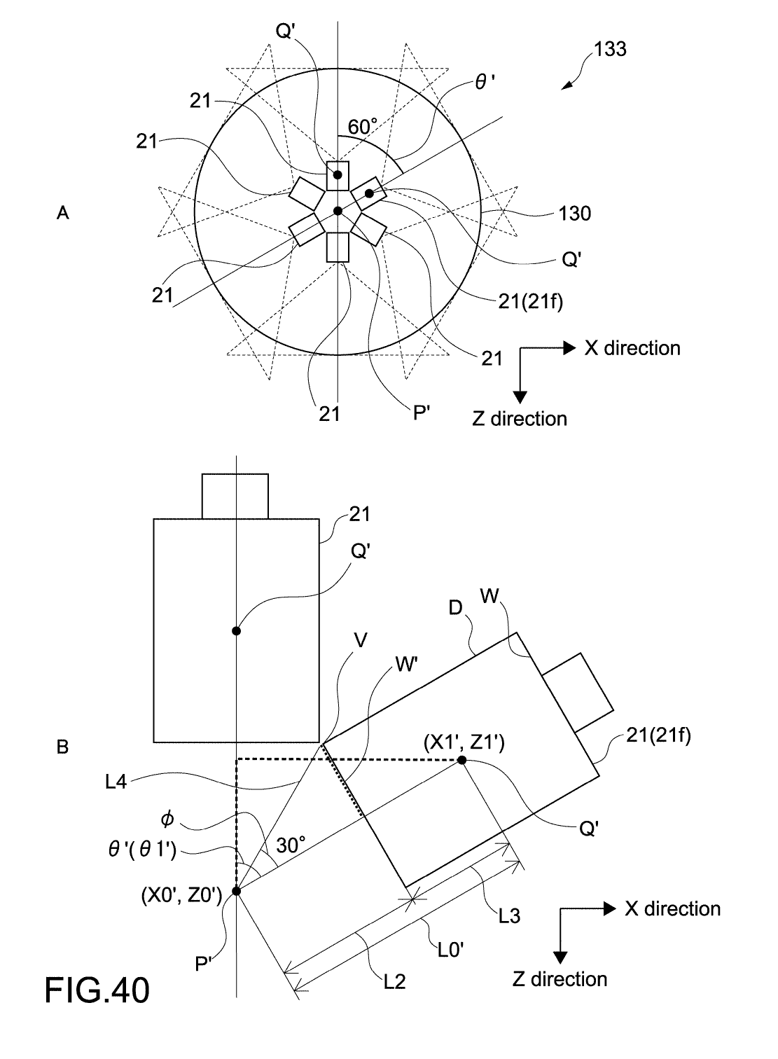

FIG. 40 is a schematic view for describing a case in which the layout of another projection mode is calculated. In FIG. 40, a mode in which an image is projected from a center P′ of a screen 130 to an outside is selected.

A reference angle θ′ is calculated from the number N of used projectors 21 (step 301). In FIG. 40A, six projectors 21 are evenly arranged inside the dome-shaped screen 130 on the basis of the center P′ of the screen 130, and 60° is calculated as the reference angle θ′.

A reference distance L0′ in a case in which an image is projected from the center P′ of the screen 130 to the outside is calculated (step 302). As shown in FIGS. 40A and 40B, a layout in which the adjacent projectors 21 are arranged in contact with each other is the smallest. In the layout, a distance from the center P′ of the screen 130 to centers Q′ of the projectors 21 is calculated as the reference distance L0′.

First, a distance L4 from the center P′ of the screen 130 to a contact point V at which the adjacent projectors 21 contact each other is calculated. As shown in FIG. 40B, a narrow angle φ formed by a straight line directed from the center P′ of the screen 130 to the center Q′ of a projector 21 and a straight line directed from the center P′ of the screen 130 to the contact point V is half the reference angle θ′ and becomes 30°. The following relationship is established between a width w′ half a width W of the projector 21, the narrow angle φ, and the distance L4.

L4×sin φ=W′=W/2

Next, a distance L2 from the center P′ of the screen 130 to the rear surface of the projector 21 is calculated. The distance L2 is calculated as follows by using the distance L4.

L2=L4×cos φ=W/2/tan φ

In addition, a value half a depth D of the projector 21 is calculated as the distance L3 from the center Q′ to the rear surface of the projector 21. That is, L3=D/2 is established.

A distance from the center P′ of the screen 130 to the center Q′ of the projector 21 is calculated as the reference distance L0′. That is, the sum of the distance L2 and the distance L3 becomes the reference distance L0′. Accordingly, the reference distance L0′ is calculated as follows.

L0′=L2+L3=W/2/tan φ+D/2

An installation angle θn′ of the n-th projector 21 is calculated from the reference angle θ′ (step 303). At this time, the angle of the pan of the n-th projector 21 is appropriately calculated on the basis of the installation angle θn′ so that projection toward the outside of the screen 130 is allowed.

The center coordinates of the n-th projector 21 are calculated from the reference distance L0′ (step 304). As shown in, for example, FIG. 40B, it is possible to calculate the coordinates of the center Q of the projector 21 from a right triangle having a line segment P′Q′ of a length L0′ as an oblique line on the basis of the center P′ of the screen 130. For example, center coordinates (X1′, Z1′) of the first projector 21f are calculated as follows.

X1′=X0′+L0′×sin(60°)

Z1′=Z0′+L0′×cos(60°)

For the second and the subsequent projectors 21, the same processing is performed to calculate the positions and the attitudes of the respective projectors 21. As described above, a layout in a case in which an image is projected from the center P′ of the screen 130 to the outside is calculated. On the basis of the calculated layout, a simulation image including a layout image 133 is generated. Thus, it becomes possible to easily understand, for example, an installation area or the like in a case in which the plurality of projectors 21 are installed at the center of the screen 130.

In the examples shown in FIGS. 39 and 40, coordinates within an XZ plane are set as the center coordinates of the screen 130. Besides, it is also possible to calculate a layout including a height (Y coordinate) at which the screen 130 is installed, a height at which the projectors 21 are installed, or the like. Thus, it becomes possible to perform a simulation having a high freedom degree.

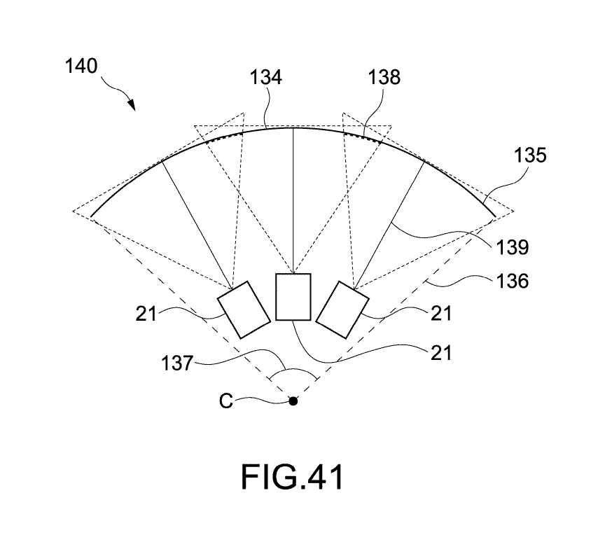

FIG. 41 is a schematic view showing an example of a layout image about a curve-shaped screen. In FIG. 41, an image is projected onto the concave side of a curve-shaped screen 134 by three projectors 21. A width 135 and a curvature radius 136 of the curve-shaped screen 134, the coordinates of a center C of the curvature radius, or the like is appropriately set by a user.

For example, a fan-shaped interior angle 137 at which the screen 134 and the center C of the curvature radius can be connected to each other is calculated. On the basis of the calculated interior angle 137, a blending width 138, or the like, an angle (reference angle) at which the screen 134 is divided by the respective projectors 21 is set. In addition, on the basis of a distance 139 (projection distance) from the respective projectors 21 to the screen 23 or the like, distances (reference distances) from the center C of the curvature radius to the projectors 21 are calculated.

The center coordinates, the attitudes, or the like of the respective projectors 21 are calculated from the reference angle and the reference distances of the respective projectors 21, and a simulation image including a layout image 140 is generated. Thus, it is possible to calculate the layout of the plurality of projectors 21 with respect to the curve-shaped screen 134. As described above, the present technology is also applicable to a screen that does not have a dome shape.

As described above, in the present embodiment, a simulation image including a layout image expressing the arrangement state (layout) of a plurality of projectors based on a screen onto which an image is to be projected is generated. Thus, it becomes possible to easily simulate an appropriate layout corresponding to the shape of a screen or the like.

When a plurality of projectors are laid out one by one with respect to a screen, the arrangements of the positions or the attitudes of the respective projectors are required to be separately set, which results in an increase in a burden on a user. In addition, for example, when a plurality of projectors are laid out with respect to a screen that does not have a flat surface shape like one having a curved shape or a dome shape, the operation of arranging the respective projectors becomes complicated. Therefore, there is a likelihood that, for example, layout accuracy decreases or an operation time increases.

In the present embodiment, a recommended layout based on a screen is automatically calculated. Thus, it becomes possible to realize, for example, a recommended layout assisting function with which a plurality of projectors are automatically arranged. Thus, the trouble of arranging projectors one by one is saved, whereby it becomes possible to substantially reduce a burden on a user. Accordingly, the user is allowed to easily advance a simulation operation. Note that the movement of the projectors described in the fourth embodiment may be used to finely adjust a layout image. Thus, it becomes possible to adjust the arrangements of the respective projectors with high accuracy.

In addition, in the present embodiment, a layout is calculated on the basis of the information of the shape of a screen or the like and the number of used projectors. For example, since a curve/dome-shaped screen has ordinality, a layout in which a plurality of projectors are evenly arranged is easily created. In the present embodiment, a recommended layout in which respective projectors are evenly arranged according to the number of the projectors is calculated by calculation logic making use of the ordinality of the screen. Accordingly, a user is allowed to create a high-accuracy layout while reducing an operation time.

Of course, for a screen having less ordinality as well, it is possible to generate and display a layout image. For example, a recommended layout can be easily calculated by the substitution of the shape of a screen with a shape having ordinality. Alternatively, a recommended layout may be calculated by the analysis of the shape of a screen.

### Other Embodiments

The present technology is not limited to the embodiments described above, but various other embodiments can be realized.

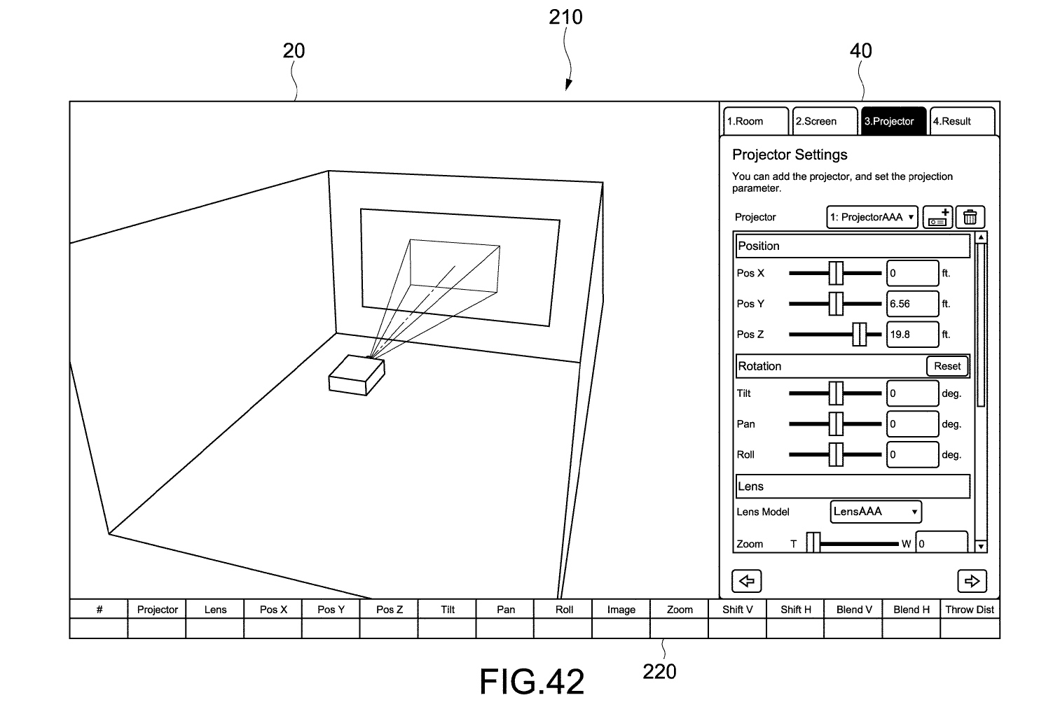

FIG. 42 is a view showing another configuration example of an application image. In an application image 210 shown in FIG. 42, a parameter display image 220 is displayed at the lower parts of the simulation image 20 and the setting image 40. Thus, since it becomes possible to easily understand input user setting parameters or projector parameters, operability is improved. Note that parameters displayed in the parameter display image 220 are not limited but any information of user setting parameters, projector parameters, and output parameters may be displayed.

The user setting parameters, the projector parameters, and the output parameters are not limited to those described above but may be appropriately set. In addition, the configurations of a simulation image, a setting image, and a description image are not limited, but any image or a GUI (Graphical User Interface) may be used.

In the above descriptions, the display region of a projected image is displayed in a simulation image. Instead of this, a prescribed image such as a landscape image stored in advance or an image based on the information of an actually projected image may be displayed in a simulation image. Thus, it becomes possible to simulate how an image is to be displayed on a curved screen, an object having a concavo-convex shape, or the like. The display of an image is realizable by displaying corresponding pixel values at, for example, collision points with extension lines in vector directions. Of course, other methods may be used.

Correction processing for a projected image may be simulated. For example, warping correction for keystone or distortion processing or the like for lens distortion or the like may be performed in a simulation image. By the employment of, for example, a projector correction algorithm, it becomes possible to simulate the correction processing. In addition, a correction limit value or the like may be calculated, and the allowable range of the tilt angles or the like of projectors may be set on the basis of the limit value.

In addition, a simulation result may be output to a 3DCADF drawing or a trihedral drawing. Thus, it becomes possible to easily perform the installation, the setting, or the like of actual projectors. In addition, a simulation may be performed when a projection environment is read from a 3DCAD drawing or the like. Thus, it becomes possible to realize a simulation corresponding to a user's installation environment. In addition, the setting of projection environment light or the brightness simulation of a projected image may be performed. Thus, a simulation corresponding to a user's installation environment is realized.

Moreover, the function (Export/Import function) of saving a simulation result in a computer such as a PC or a web server as a file or loading saved data may be provided. With the Export/Import function, it becomes possible to save a simulation operation or deliver an operation between a plurality of persons.

The present technology is applicable also to a simulation by an image projection apparatus other than a projector.

The above embodiments describe the cases in which the information processing method according to the present technology is performed by a computer such as a PC operated by a user. However, the information processing method and the program according to the present technology may be performed by other computers capable of communicating with a computer operated by a user via a network or the like. In addition, a computer operated by a user and other computers may operate in conjunction with each other to construct a simulation system according to the present technology.

That is, the information processing method and the program according to the present technology can be performed not only in a computer system constructed by a single computer but also in a computer system in which a plurality of computers operate in conjunction with each other. Note that in the present disclosure, a system represents a group of a plurality of constituents (such as apparatuses and modules (components)) and does not care about whether all the constituents are included in the same housing. Accordingly, both a plurality of apparatuses accommodated in separate housings and connected to each other via a network and an apparatus in which a plurality of modules are accommodated in a housing constitute a system.

The implementation of the information processing method and the program according to the present technology by a computer system include both a case in which the acquisition of setting information and the generation of a simulation image or the like are, for example, performed by a single computer and a case in which respective processing is performed by different computers. In addition, the implementation of respective processing by a prescribed computer includes causing other computers to perform a part or all of the processing to acquire the results.

That is, the information processing method and the program according to the present technology is also applicable to the configuration of cloud computing in which a function is shared and cooperatively processed among a plurality of apparatuses via a network.

Among the characteristic parts according to the present technology described above, it is also possible to combine at least two of the characteristic parts together. That is, the various characteristic parts described in the respective embodiments may be arbitrarily combined together without the distinction of the respective embodiments. In addition, the various effects described above are given for illustration purpose and are not limitative, but other effects may be produced.

Note that the present technology can also employ the following configurations.

(1) An information processing apparatus, including:

an acquisition unit that acquires setting information regarding projection of an image by an image projection apparatus; and

a generation unit that generates a simulation image including a plurality of image projection apparatuses and respective display regions of a plurality of images projected by the plurality of image projection apparatuses on the basis of the acquired setting information.

(2) The information processing apparatus according to (1), in which

the setting information includes user setting information set by a user, and

the generation unit generates the simulation image on the basis of the user setting information.

(3) The information processing apparatus according to (2), in which

the user setting information includes information of a type of the image projection apparatus.

(4) The information processing apparatus according to (2) or (3), in which

the user setting information includes information of a lens used in the image projection apparatus.

(5) The information processing apparatus according to any one of (2) to (4), in which

the user setting information includes at least one of a position, an attitude, a lens shift amount, or an aspect ratio of an image of the image projection apparatus.

(6) The information processing apparatus according to any one of (2) to (5), in which

the user setting information includes information of a blending width, and

the generation unit generates the simulation image including a guide frame based on the information of the blending width.

(7) The information processing apparatus according to any one of (2) to (6), in which

the user setting information includes a command to duplicate a first image projection apparatus in the simulation image, and

the generation unit generates the simulation image including a second image projection apparatus duplicated at a same position as the first image projection apparatus according to the command.

(8) The information processing apparatus according to any one of (2) to (7), in which

the user setting information includes information of space in which the plurality of image projection apparatuses are used, and

the generation unit generates the simulation image including the space.

(9) The information processing apparatus according to any one of (2) to (8), in which

the user setting information includes information of a projected object onto which the image is to be projected, and

the generation unit generates the simulation image including the projected object.

(10) The information processing apparatus according to any one of (1) to (9), further including:

a storage unit that stores type setting information set for each type of the image projection apparatus, in which

the acquisition unit acquires the type setting information from the storage unit, and

the generation unit generates the simulation image on the basis of the acquired type setting information.

(11) The information processing apparatus according to (10), in which

the type setting information includes information of an offset between a center of gravity of a housing of the image projection apparatus and a position of a virtual light source.

(12) The information processing apparatus according to any one of (1) to (11), in which

the generation unit generates the simulation image including a projected image that is an image projected by the image projection apparatus.

(13) The information processing apparatus according to (12), in which

the acquisition unit acquires image information of an image selected by the user, and

the generation unit generates the simulation image including the projected image on the basis of the acquired image information.

(14) The information processing apparatus according to (12) or (13), in which

the generation unit is capable of changing transmittance of the projected image.

(15) The information processing apparatus according to (14), in which

the generation unit is capable of changing the transmittance for each pixel of the projected image.

(16) The information processing apparatus according to (14) or (15), in which

the generation unit determines the transmittance on the basis of at least one of a distance to the projected object onto which the projected image is to be projected, characteristics of the lens used in the image projection apparatus, or reflectance of the projected object.

(17) The information processing apparatus according to any one of (1) to (16), in which

the generation unit generates the simulation image including distortion of the image projected by the image projection apparatus.

(18) The information processing apparatus according to (17), further including

a determination unit that determines whether the distortion of the image is correctable, in which

the generation unit generates the simulation image including a notification image that notifies a determination result by the determination unit.

(19) The information processing apparatus according to (18), in which

the determination unit determines whether the distortion of the image is correctable on the basis of at least one of the distortion of the image or information of a distortion correction function of the image projection apparatus.

(20) The information processing apparatus according to any one of (17) to (19), in which

the generation unit generates the simulation image including an image expressing a range in which the distortion of the image is correctable.

(21) The image projection apparatus according to any one of (2) to (20), in which

the user setting information includes a movement amount along a direction of a light axis of the image projection apparatus.

(22) The information processing apparatus according to any one of (2) to (21), in which

the user setting information includes a movement amount of movement based on a shape of the projected object onto which the image is to be projected.

(23) The information processing apparatus according to (22), in which

the movement based on the shape of the projected object is movement along the shape of the projected object.

(24) The information processing apparatus according to (22) or (23), in which

the movement based on the shape of the projected object is movement in which an angle of the light axis of the image projection apparatus with respect to the projected object is maintained.

(25) The information processing apparatus according to any one of (1) to (24), in which

the generation unit generates the simulation image including a layout image expressing arrangement states of the plurality of image projection apparatuses based on the projected object onto which the image is to be projected.

(26) The information processing apparatus according to (25), in which

the user setting information includes information of the projected object and the number of the image projection apparatuses, and

the generation unit generates the simulation image including the layout image on the basis of the information of the projected object and the number of the image projection apparatuses.

(27) The information processing apparatus according to any one of (1) to (26), in which

the generation unit generates a setting image for setting the user setting information.

(28) The information processing apparatus according to (27), in which,

when the user setting information that is invalid is input, the generation unit generates the setting image in which the user setting information that is invalid is highlighted.

### REFERENCE SIGNS LIST

1 user
20 simulation image
21, 21a to 21f projector
22 room
23, 130, 134 screen
24, 24a to 24d display region
26 light axis
40 setting image
41 first setting image
42 second setting image
43 third setting image
62 housing
66, 66a, 66b, 66ab, 66cd blending guide
68 apparatus addition image
75 list image
78 projected image
79 source image
94 notification image
96 correction region
100 information processing apparatus
106 display unit
107 operation unit
108 storage unit
115 parameter acquisition unit
116 image generation unit
122 movement setting image
131, 133, 140 layout image

1. An information processing apparatus, comprising:
an acquisition unit that acquires setting information regarding projection of an image by an image projection apparatus; and
a generation unit that generates a simulation image including a plurality of image projection apparatuses and respective display regions of a plurality of images projected by the plurality of image projection apparatuses on a basis of the acquired setting information.

2. The information processing apparatus according to claim 1, wherein
the setting information includes user setting information set by a user, and
the generation unit generates the simulation image on a basis of the user setting information.

3. The information processing apparatus according to claim 2, wherein
the user setting information includes information of a type of the image projection apparatus.

4. The information processing apparatus according to claim 2, wherein
the user setting information includes information of a lens used in the image projection apparatus.

5. The information processing apparatus according to claim 2, wherein
the user setting information includes at least one of a position, an attitude, a lens shift amount, or an aspect ratio of an image of the image projection apparatus.

6. The information processing apparatus according to claim 2, wherein
the user setting information includes information of a blending width, and
the generation unit generates the simulation image including a guide frame based on the information of the blending width.

7. The information processing apparatus according to claim 2, wherein
the user setting information includes a command to duplicate a first image projection apparatus in the simulation image, and
the generation unit generates the simulation image including a second image projection apparatus duplicated at a same position as the first image projection apparatus according to the command.

8. The information processing apparatus according to claim 2, wherein
the user setting information includes information of space in which the plurality of image projection apparatuses are used, and
the generation unit generates the simulation image including the space.

9. The information processing apparatus according to claim 2, wherein
the user setting information includes information of a projected object onto which the image is to be projected, and
the generation unit generates the simulation image including the projected object.

10. The information processing apparatus according to claim 1, further comprising:
a storage unit that stores type setting information set for each type of the image projection apparatus, wherein
the acquisition unit acquires the type setting information from the storage unit, and
the generation unit generates the simulation image on a basis of the acquired type setting information.

11. The information processing apparatus according to claim 10, wherein
the type setting information includes information of an offset between a center of gravity of a housing of the image projection apparatus and a position of a virtual light source.

12. The information processing apparatus according to claim 1, wherein
the generation unit generates the simulation image including a projected image that is an image projected by the image projection apparatus.

13. The information processing apparatus according to claim 12, wherein
the acquisition unit acquires image information of an image selected by the user, and
the generation unit generates the simulation image including the projected image on a basis of the acquired image information.

14. The information processing apparatus according to claim 12, wherein
the generation unit is capable of changing transmittance of the projected image.

15. The information processing apparatus according to claim 14, wherein
the generation unit is capable of changing the transmittance for each pixel of the projected image.

16. The information processing apparatus according to claim 14, wherein
the generation unit determines the transmittance on a basis of at least one of a distance to the projected object onto which the projected image is to be projected, characteristics of the lens used in the image projection apparatus, or reflectance of the projected object.

17. The information processing apparatus according to claim 1, wherein
the generation unit generates the simulation image including distortion of the image projected by the image projection apparatus.

18. The information processing apparatus according to claim 17, further comprising
a determination unit that determines whether the distortion of the image is correctable, wherein
the generation unit generates the simulation image including a notification image that notifies a determination result by the determination unit.

19. The information processing apparatus according to claim 18, wherein
the determination unit determines whether the distortion of the image is correctable on a basis of at least one of the distortion of the image or information of a distortion correction function of the image projection apparatus.

20. The information processing apparatus according to claim 17, wherein
the generation unit generates the simulation image including an image expressing a range in which the distortion of the image is correctable.

21. The image projection apparatus according to claim 2, wherein
the user setting information includes a movement amount along a direction of a light axis of the image projection apparatus.

22. The information processing apparatus according to claim 2, wherein
the user setting information includes a movement amount of movement based on a shape of the projected object onto which the image is to be projected.

23. The information processing apparatus according to claim 22, wherein
the movement based on the shape of the projected object is movement along the shape of the projected object.

24. The information processing apparatus according to claim 22, wherein
the movement based on the shape of the projected object is movement in which an angle of the light axis of the image projection apparatus with respect to the projected object is maintained.

25. The information processing apparatus according to claim 1, wherein
the generation unit generates the simulation image including a layout image expressing arrangement states of the plurality of image projection apparatuses based on the projected object onto which the image is to be projected.

26. The information processing apparatus according to claim 25, wherein
the user setting information includes information of the projected object and the number of the image projection apparatuses, and
the generation unit generates the simulation image including the layout image on a basis of the information of the projected object and the number of the image projection apparatuses.

27. The information processing apparatus according to claim 1, wherein
the generation unit generates a setting image for setting the user setting information.

28. The information processing apparatus according to claim 27, wherein,
when the user setting information that is invalid is input, the generation unit generates the setting image in which the user setting information that is invalid is highlighted.

29. An information processing method performed by a computer system, the method comprising:
acquiring setting information regarding projection of an image by an image projection apparatus; and
generating a simulation image including a plurality of image projection apparatuses and respective display regions of a plurality of images projected by the plurality of image projection apparatuses on a basis of the acquired setting information.

30. A program that causes a computer system to perform:
a step of acquiring setting information regarding projection of an image by an image projection apparatus; and
a step of generating a simulation image including a plurality of image projection apparatuses and respective display regions of a plurality of images projected by the plurality of image projection apparatuses on a basis of the acquired setting information.
